(19) United States
(12) Patent Application Publication
(10) Pub. No.: US 2014/0320915 A1
(43) Pub. Date: Oct. 30, 2014

(54) IMAGE PROCESSING APPARATUS

(71) Applicant: Oki Data Corporation, Tokyo (JP)

(72) Inventor: Atsushi OWARI, Tokyo (JP)

(73) Assignee: Oki Data Corporation, Tokyo (JP)

(21) Appl. No.: 14/260,776

(22) Filed: Apr. 24, 2014

(30) Foreign Application Priority Data
Apr. 30, 2013 (JP) 2013-095462

(51) Int. Cl. H04N 1/00

(52) U.S. Cl. CPC H04N 1/00384
USPC 358/1.15

(57) ABSTRACT

An image processing apparatus includes a display part that displays a screen; a display control part that displays one of a first display screen and a second display screen on the display part; a first operation key that is pressed by a user, and a control part that executes a first process when the first operation key is pressed by the user while the first display screen is displayed on the display part, and executes a second process when the first operation key is pressed by the user while the second display screen is displayed on the display part.

### CROSS-REFERENCE TO RELATED APPLICATION

The present application is related to, claims priority from and incorporates by reference Japanese Patent Application No. 2013-095462, filed on Apr. 30, 2013

### TECHNICAL FIELD

The present invention relates to an image processing apparatus. The present invention can be applied to, for example, an image processing apparatus that has one or more operation keys that are respectively assignment plural actions (processes) and executes any one or more of the processes.

### BACKGROUND OF THE INVENTION

Conventionally, there has been an invention that one operation key is assigned plural processes and any one or more of the processes are executed according to an operation method (see Japanese Laid-Open Patent Application No. 2010-278502).

Meanwhile, when one operation key is assigned plural processes, a user operation to choose a process that a user wants to reach is complicated.

Therefore, an image processing apparatus that a process that is assigned to one operation key can be chosen more easily than the conventional invention is needed.

Considering the above issues, an image processing apparatus disclosed in the application includes a display part that displays a screen; a display control part that displays one of a first display screen and a second display screen on the display part; a first operation key that is pressed by a user, and a control part that executes a first process when the first operation key is pressed by the user while the first display screen is displayed on the display part, and executes a second process when the first operation key is pressed by the user while the second display screen is displayed on the display part.

According to the present invention, a process assigned to an operation key can be easily chosen.

### BRIEF DESCRIPTION OF DRAWINGS

FIG. 1 is a configuration view that illustrates a configuration of an image processing apparatus according to a first embodiment.

FIG. 2 is an appearance configuration view that illustrates an appearance configuration of an operation panel according to the first embodiment.

FIG. 3 is an explanatory view that explains a method of registering destination information according to the first embodiment, using screen transitions of a display part (part 1).

FIG. 4 is an explanatory view that explains a method of registering destination information according to the first embodiment, using screen transitions of the display part (part 2).

FIG. 5 is an explanatory view that explains a method of registering setting information according to the first embodiment, using screen transitions of the display part (part 1).

FIG. 6 is an explanatory view that explains a method of registering setting information according to the first embodiment, using screen transitions of the display part (part 2).

FIG. 7 is a configuration view that illustrates a configuration of a key assignment table as assignment information of a key assignment part according to the first embodiment.

FIG. 8 is an explanatory view that explains a screen transition when an one touch key according to the first embodiment is pressed.

FIG. 9 is an explanatory view that explains an operation switch order when the one touch key according to the first embodiment is repeatedly pressed.

FIG. 10 is a flow diagram that illustrates a process when the one touch key in the image processing apparatus according to the first embodiment is pressed.

FIG. 11 is a sequence diagram that illustrates a process when the one touch key in the image processing apparatus according to the first embodiment is pressed.

FIG. 12 is a flow diagram that illustrates an obtaining process of the destination information according to the first embodiment.

FIG. 13 is a flow diagram that illustrates the obtaining process of the setting information according to the first embodiment.

FIG. 14 is a flow diagram that illustrates a switch process of assignment actions.

FIG. 15 is a sequence diagram that shows a switch process of assignment actions when the one touch key according to the first embodiment is pressed.

FIG. 16 is a screen view that illustrates screen examples that are displayed in a display part according to the first embodiment.

FIG. 17 is a configuration view that illustrates a configuration of an image processing apparatus according to a second embodiment.

FIG. 18 is an appearance configuration view that illustrates an appearance configuration of an operation panel according to the second embodiment.

FIG. 19 is a configuration view that illustrates a configuration of a key assignment table as assignment information of a key assignment part according to the second embodiment.

FIG. 20 is a flow diagram that illustrates a process when one touch keys in the image processing apparatus according to the second embodiment are pressed.

FIG. 21 is a sequence diagram that illustrates a process when the one touch keys in the image processing apparatus according to the second embodiment are pressed.

FIG. 22 is a flow diagram that illustrates an action selection process in a key assignment switch control part at the time of a first time pressing of the one touch key according to the second embodiment (part 1).

FIG. 23 is a flow diagram that illustrates the action selection process in the key assignment switch control part at the time of the first time pressing of the one touch key according to the second embodiment (part 2).

FIG. 24 is a flow diagram that illustrates the action selection process in the key assignment switch control part at the time of the first time pressing of the one touch key according to the second embodiment (part 3).

FIG. 25 is a flow diagram that illustrates the action selection process in the key assignment switch control part at the time of the first time pressing of the one touch key according to the second embodiment (part 4).

FIG. 26 is a flow diagram that illustrates the action selection process in the key assignment switch control part at the time of the first time pressing of the one touch key according to the second embodiment (part 5).

FIG. 27 is a flow diagram that illustrates an action selection process when the one touch key according to the second embodiment is repeatedly pressed several times.

FIG. 28 is a sequence diagram that illustrates the action selection process when the one touch key according to the second embodiment is repeatedly pressed several times (part 1).

FIG. 29 is a sequence diagram that illustrates the action selection process when the one touch key according to the second embodiment is repeatedly pressed several times (part 2).

FIG. 30 is a screen view that illustrates screen examples that are displayed in a display part according to the second embodiment.

FIG. 31 is a flow diagram that illustrates an action selection process in a key assignment switch control part at the time of a second or subsequent time pressing of the one touch key according to the second embodiment (part 1).

FIG. 32 is a flow diagram that illustrates an action selection process in the key assignment switch control part at the time of the second or subsequent time pressing of the one touch key according to the second embodiment (part 2).

FIG. 33 is a flow diagram that illustrates an action selection process in the key assignment switch control part at the time of the second or subsequent time pressing of the one touch key according to the second embodiment (part 3).

FIG. 34 is a flow diagram that illustrates an action selection process in the key assignment switch control part at the time of the second or subsequent time pressing of the one touch key according to the second embodiment (part 4).

FIG. 35 is a flow diagram that illustrates an action selection process in the key assignment switch control part at the time of the second or subsequent time pressing of the one touch key according to the second embodiment (part 5).

### DETAILED DESCRIPTION OF EMBODIMENTS

### (A) First Embodiment

Hereinafter, an image processing apparatus according to a first embodiment of the present invention is explained in detail referring to the drawings.

In the first embodiment, as an example, a form in a case where the present invention is applied to a multifunction peripheral (MFP) that includes plural functions such as copier function, scanning function, printing function, facsimile function, and network communication function, etc., for example, is described.

(A-1) Configuration of First Embodiment

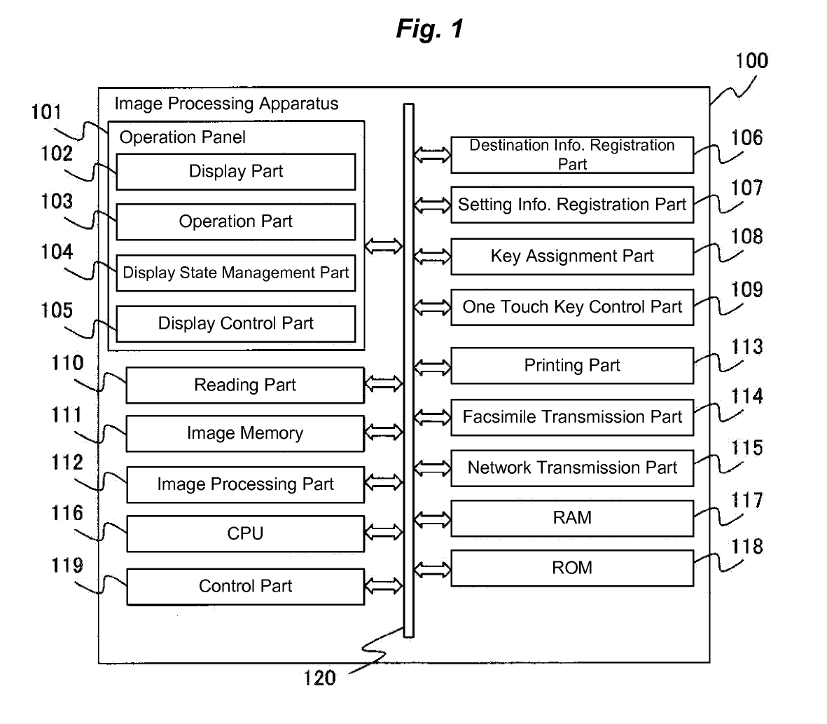

FIG. 1 is a configuration view that illustrates a configuration of the image processing apparatus according to the first embodiment.

In FIG. 1, an image processing apparatus 100 according to the first embodiment includes an operation panel 101, a destination information registration part 106, a setting information registration part 107, a key assignment part 108, a one touch control part 109, a reading part 110, an image memory 111, an image processing part 112, a printing part 113, a facsimile transmission part 114, a network transmission part 115, an CPU 116, a RAM 117, a ROM 118, and a control part 119, and those are connectable to a common bus 120.

The common bus 120 is a signal line that connects elements that the image processing apparatus 100 includes.

The operation panel 101 is an operation display unit of the image processing apparatus 100. The operation panel 101 displays a setting item related to a image process, receives an input of a setting and change of a setting value of the setting item by a user operation, and receives an registration of destination information of an email and facsimile of image data by a user operation.

The operation part 101 includes a display part 102, an operation part 103, a display state management part 104, and a display control part 105.

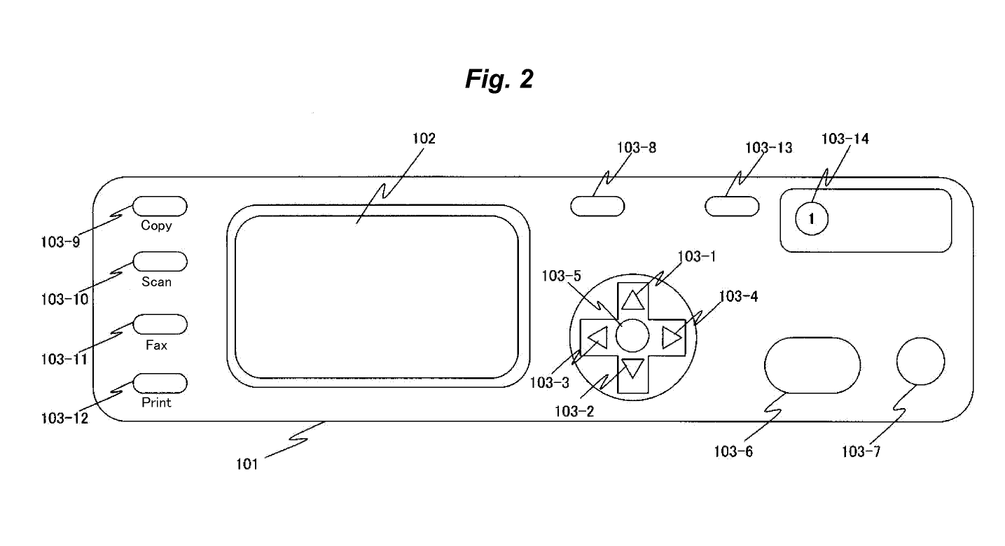

FIG. 2 is an appearance configuration view that illustrates an appearance configuration of the operation panel 101 according to the first embodiment. In FIG. 2, the operation panel 101 includes the display part 102 and the operation part 103.

The display part 102 displays a state of the image processing apparatus 100, a screen of a function, and input information input via the operation part 103. For example, a liquid crystal display (LCD), etc., is applicable.

The operation part 103 consists of operation buttons and a directional pad, etc. that a user operates. The operation part 103, as illustrated in FIG. 2, is used for input of various setting information and selection of various functions of the image processing apparatus 100. Note, the operation part 103 may consist of a unit, such as a touch panel, in which a display part and an operation part are physically integrated.

The operation part 103 includes, as illustrated in FIG. 2, an up key 103-1, a down key 103-2, a left key 103-3, a right key 103-4, and a determination key 103-5, for example. The up key 103-1 moves a pointer displayed in the display part 102 upward. The down key 103-2 moves the pointer downward. The left key 103-3 moves the pointer to the left side. The right key 103-4 moves the pointer to the right side. Also, the operation part 103 includes a start key 103-6 that instructs an action to the image processing apparatus 100; a cancel key 103-7 that cancels an action of the image processing apparatus 100; a device setting key 103-8 that performs a device setting of the image processing apparatus 100; a copier key 103-9 that lets the copier function act; a scanning function key 103-10 that lets the scanning function act; a facsimile key 103-11 that lets the facsimile function act; and a printing key 103-12 that lets the printing function acts. Furthermore, the operation part 103 includes a setting information registration key 103-13 that lets a registration process of setting information act, and a one touch key 103-14 (that may be referred to as a first operation key).

Herein, the one touch key 103-14 is an operation key that is assigned plural processes. The operation panel 101 in FIG. 2 exemplifies a case where one piece of the one touch key 103-14 is included however plural pieces of the one touch key 103-14 may be included. In this embodiment, the first operation key was embodied with a key named “One Touch,” the key may be executed by a double click or double touch as long as the user is able to initiate the registered processes with a simple action. Regarding the key operations, not only touching but other common operations recognized on a touch screen such as swiping or pinching also may be applied. The one touch key may be realized with a physical independent button or switch etc.

The display state management part 104 manages a state of screen displayed in the display part 102. The display state management part 104 updates the state of screen displayed in the display part 102 by a control of the display control part 105. The display state management part 104 gives a current state of the display screen to the display control part 105 upon the receipt of a request to obtain a display screen state from the display control part 105.

For example, the display state management part 104 distinguishes an application such as the copier function, the scanning function, the facsimile function, the printing function, and an email function, etc., and manages a screen type of the display screen of each application. Then, when the request to obtain a state is given from the display control part 105, the display state management part 104 distinguishes the screen type of a currently running application, and gives the state of the current display screen to the display control part 105.

The display control part 105 displays a corresponding display screen on the display part 102 based on a selection signal from the operation part 103.

Also, when the one touch key 103-14 is selected, the display control part 105 performs the request to obtain a state of the current display screen to the display state management part 104, and obtains current display state information. The display control part 105 notifies the one touch key control part 109 (that may be referred to as a control part) of obtained current display state information and a status that the one touch key 103-14 has been pressed. Note, in a case where the one touch key 103-14 is repeatedly pressed several times, when the pressing notification is received for second or subsequent time, the display control part 105 doesn't perform obtaining or notification of the display state information again to the one touch key control part 109. In the specification, repeatedly is used to describe a situation that one touch key is repeatedly pressed without another operation intervening between the continuous pressings of the one touch key.

Furthermore, the display control part 105 obtains behavior information (hereinafter, referred to as action information as well) in correspondence with the pressing of the one touch key 103-14 such that the display part 102 displays a screen corresponding to the action information. The destination information registration part 106 stores destination information for transmission by email and facsimile of image data read by the reading part 110 that is described below.

Herein, a function of sending image data read by the reading part 110 by email is also called a Scan To Email function. A function of sending image data read by the reading part 110 by facsimile is also called a Scan To Fax function. Furthermore, a function of sending image data read by the reading part 110 to a terminal (for example, personal computer (PC)) on a network is called a Scan To Network PC function.

The destination information registration part 106 stores an address book that is used for destination designation of the Scan To Email function, a phone book that is used for destination designation of the Scan To Fax function, and destination information of a profile that is used for destination designation of the Scan To Network PC.

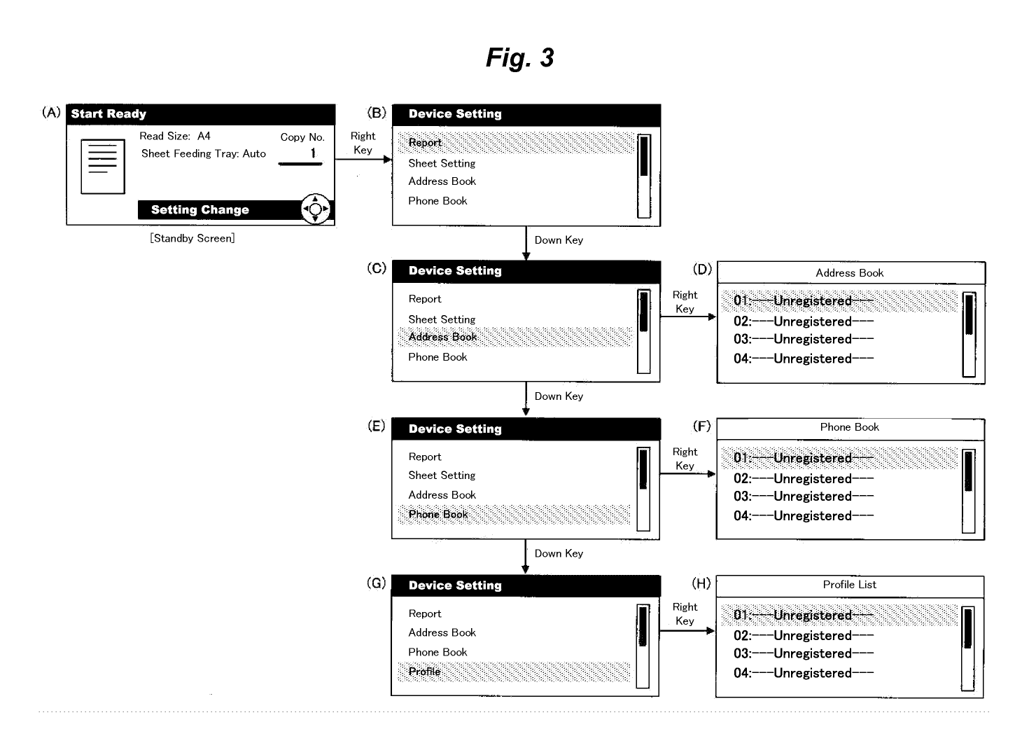

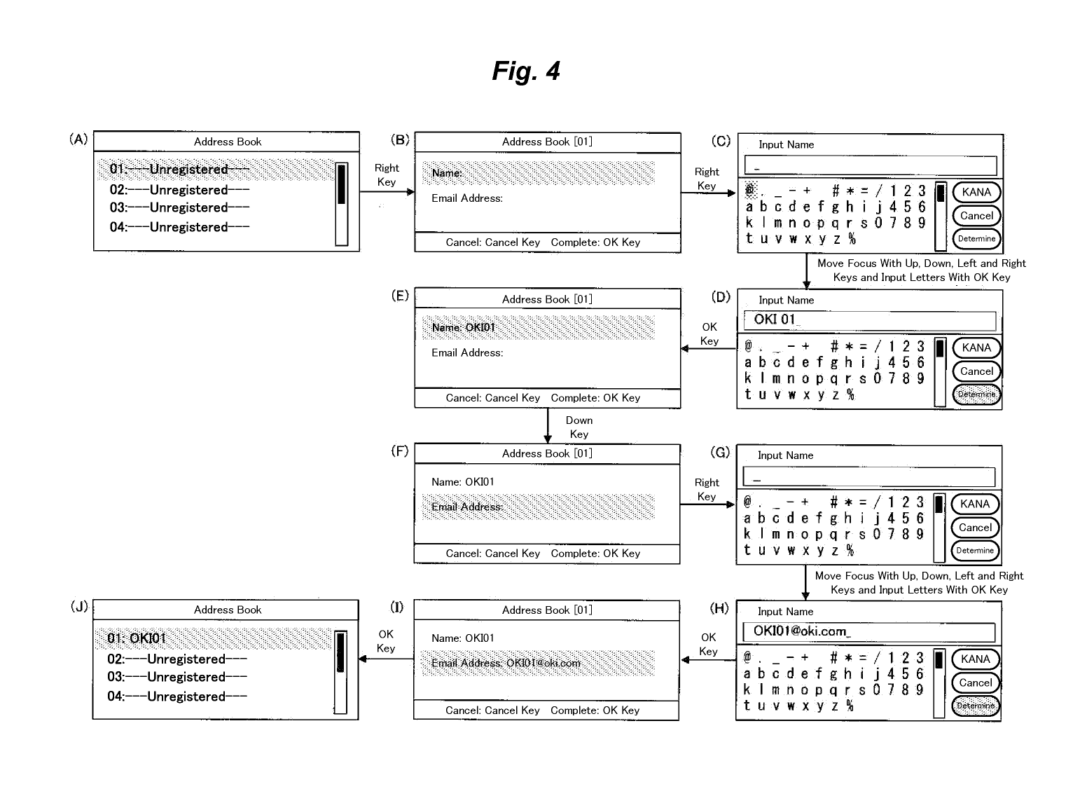

A method of registering the destination information is not specifically limited, and various methods are applicable. For example, as an example of the method of registering the destination information, a method exemplified in FIGS. 3 and 4 is applicable.

FIG. 3 and FIG. 4 are explanatory views that explain a method of registering destination information using screen transitions of the display part 102.

FIG. 3(A) is an example of a standby screen displayed on the display part 102. Under the state, when the device setting key 103-8 is pressed, a screen shown in FIG. 3(B) is displayed on the display part 102. As screen examples of FIGS. 3(B), 3(C), 3(E) and 3(G) show, there are for example “report,” “sheet setting,” “address book,” “phone book,” “profile,” etc. as a target of the device setting.

For example, when destination information of “address book” is registered, by selecting “address book” as shown in FIG. 3(C), a screen of FIG. 3(D) is displayed. The numbers such as “01,” “02,” “03,” and “04” in the screen of FIG. 3(D) are registration numbers of the destination information, and correspond to numbers that identify the one touch key 103-14.

When the screen of FIG. 3(D) is displayed, the destination information of the address book is registered following the screen transition illustrated in FIGS. 4(A)-4(J). When the number “01” is selected on the screen of FIG. 4(A), an address book registration screen of FIG. 4(B) is displayed. When “Name” is selected, an input screen of FIG. 4(C) is displayed to allow input. When “Determine” is selected as FIG. 4(D) illustrates, the address book registration screen of FIG. 4(E) is displayed again. At this point, an input name is displayed as a screen example of FIG. 4(E) shows. Next, when “Mail Address” is selected as FIG. 4(F) shows, an input screen of FIG. 4(G) is displayed to allow input. When “Determine” is selected as FIG. 4(H) shows, the address book registration screen of FIG. 4(I) is displayed again. Then, when “Complete” is selected, a screen of the address book of FIG. 4(J) is displayed again.

Note, since a procedure that is the same as or corresponds to the procedure for the destination information of “Address Book” that is described above is applicable to a method of registering the destination information of “Phone Book” (see FIG. 3(E) and FIG. 3(F)) and “Profile” (see FIG. 3(G) and FIG. 3(H)), explanation thereof is omitted herein.

The setting information registration part 107 stores setting information for executing the plural functions such as the copier function, the scanning function, the printing function, the facsimile function, and the network communication function, etc.

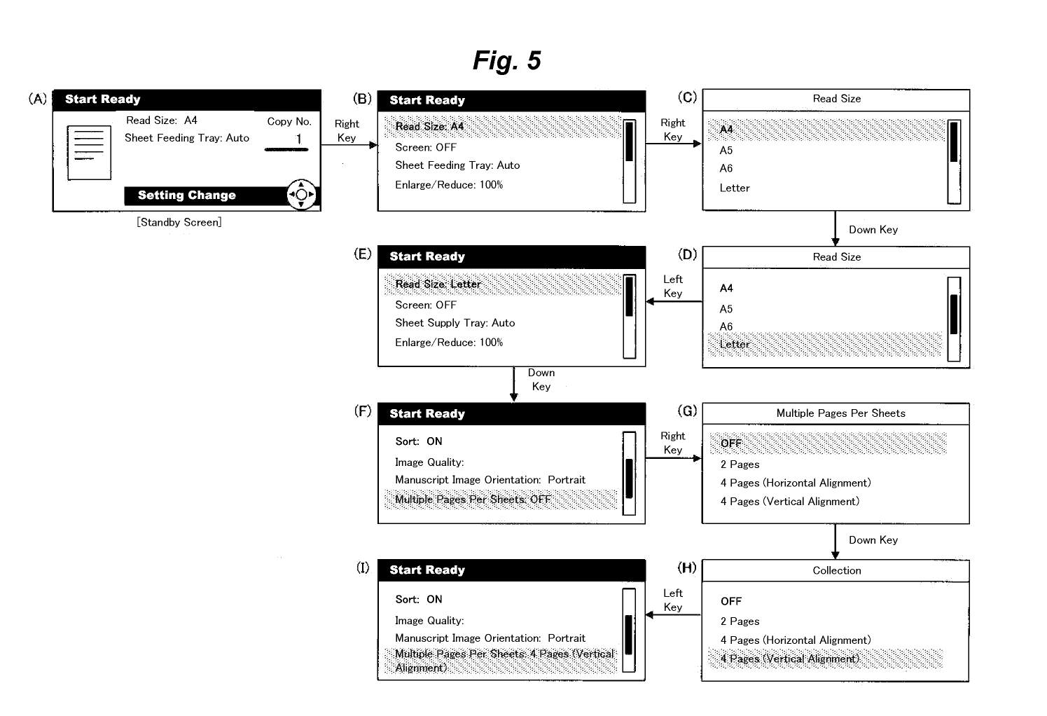

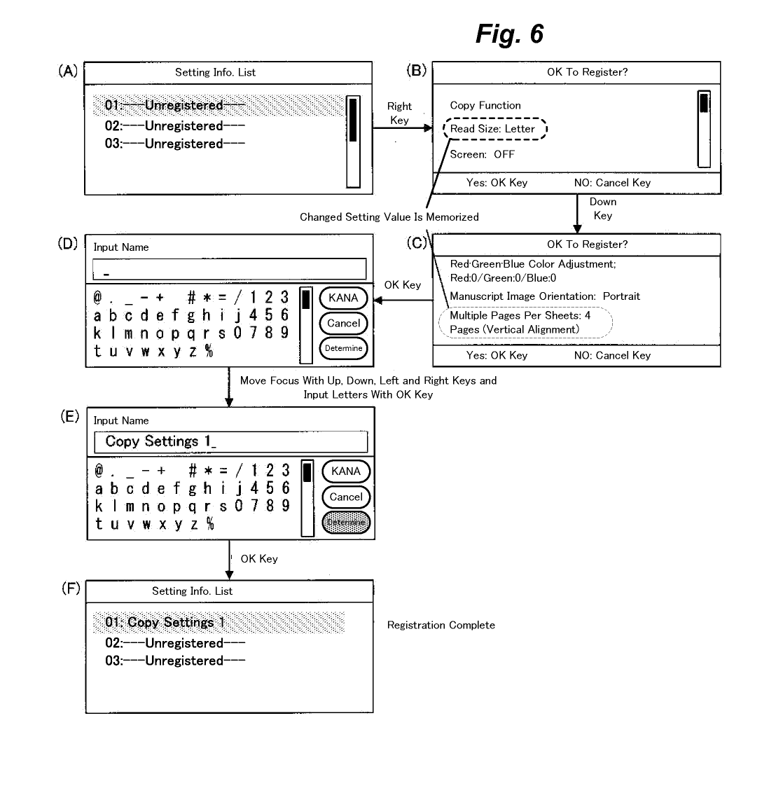

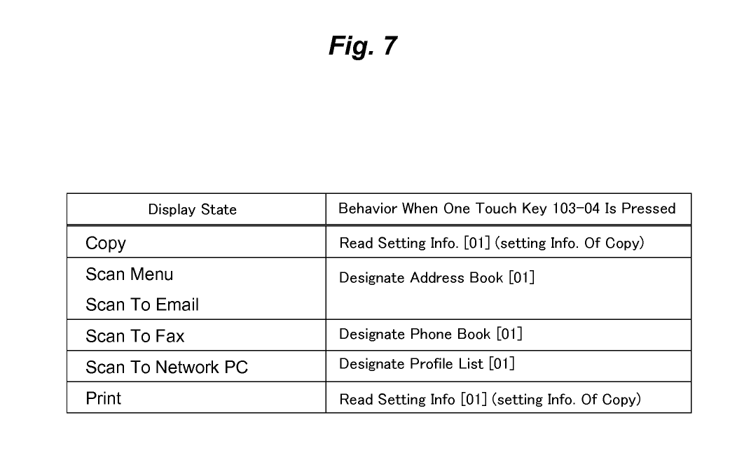

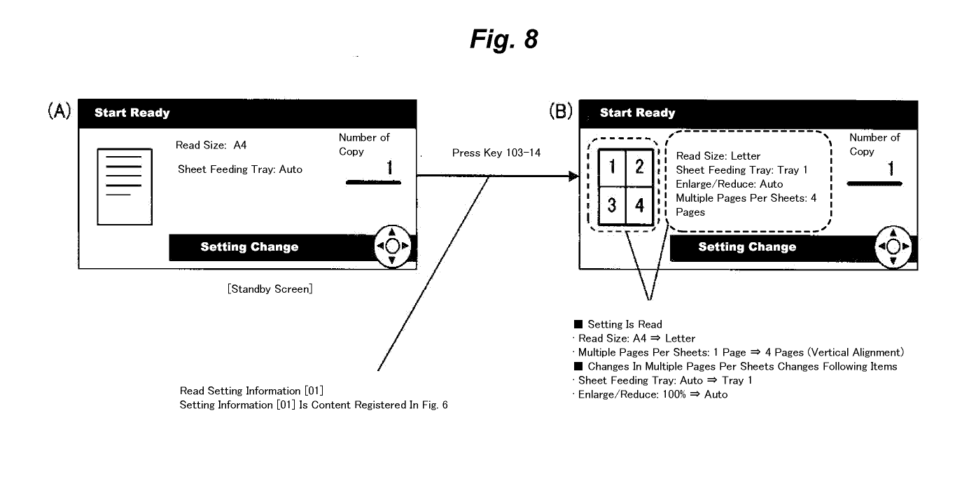

As a method of registering the setting information, various method are applicable. For example, as an example of the method of registering the setting information, a method exemplified in FIG. 5 and FIG. 6 is applicable.

FIG. 5 and FIG. 6 are explanatory views that explain a method of registering setting information using screen transitions of the display part 102. Note, FIG. 5 and FIG. 6 also exemplify a case when setting information of the copier function is registered, for example. Setting information of the other functions is able to be registered by the same method as the one illustrated in FIG. 5 and FIG. 6.

FIG. 5(A) shows an example of a standby screen displayed on the display part 102. When the right key 103-4 is pressed, a screen of FIG. 5(B) is displayed on the display part 102. As screen examples of FIG. 5(B), FIG. 5(E), FIG. 5(F), and FIG. 5(I) illustrate, there are for example “Read Size,” “Double Sided,” “Sheet Feeding Tray,” “Enlarge/Reduce,” “Sort,” “Image Quality,” “Manuscript Image Orientation,” and “Multiple Pages Per Sheet,” etc.

For example, in order to set the setting items to be “Read Size: Letter” and “Multiple Pages Per Sheet: 4 Pages (Vertical Alignment),” “Read Size” on the screen of FIG. 5(B) is selected, the selection screen of FIG. 5(C) is displayed, and “Letter” is selected as FIG. 5(D) illustrates. Then, the screen turns to the screen of FIG. 5(E), “Multiple Pages Per Sheet” is selected as FIG. 5(F) illustrates, the selection screen of FIG. 5(G) is displayed, and “4 Pages (Vertical Alignment)” that layouts four pages of scanned manuscript images on one sheet in a vertical manner is selected. Then, the screen of FIG. 5(I) is displayed again.

When the setting information registration key 103-13 is pressed while the screen of FIG. 5(I) is displayed on the display part 102, a setting information list screen of FIG. 6(A) is displayed. In the screen of FIG. 6(A), the numbers such as “01,” “02,” and “03” are registration numbers of the destination information, and correspond to numbers that identify the one touch key 103-14. When the number “01” is selected on the screen of FIG. 6(A), as illustrated in FIG. 6(B) and FIG. 6(C), a setting value set following the procedure of FIG. 5 is displayed. When the determination key 103-5 on the screen of FIG. 6(C) is pressed, a name input screen is displayed as FIG. 6(D) illustrates to allow input. Then, when “determination” is selected on the screen of FIG. 6(E), as FIG. 6(F) illustrates, setting information of this time is registered in the setting information list “01”.

As illustrated in FIGS. 5(A)-5(I) and FIGS. 6(A)-6(F), for example, it is possible to store, name, and register setting values of all setting items related to the copier function including setting items changed by pressing the setting information registration key 103-13 after changing setting values of the setting items such as the Read Size and the multiple pages per sheet as one group of setting values before the copier function is executed.

The key assignment part 108 assigns information registered in the destination information registration part 106 and the setting information registration part 107 to the one touch key 103-14.

Also, the key assignment part 108 manages a display state of the display part 102 when the one touch key 103-14 is pressed and an action to be executed after pressing the one touch key 103-14.

FIG. 7 is the configuration view that illustrates a configuration of a key assignment table as assignment information of the key assignment part 108. In the key assignment table in FIG. 7, four actions of “Read Setting Information [01],” “Designate Address Book [01],” “Designate Phone Book [01],” and “Designate Profile List [01]” are assigned to the one touch key 103-14.

Also, in the key assignment table in FIG. 7, an action to start is assigned based on a current display state of the display part 102, “Display State” and “Behavior When One Touch Key Is Pressed” are corresponded. Note, in FIG. 7, “Behavior When One Touch Key Is Pressed” of both “Copy” state and “Print” state show a case where “Read Setting Information [01]” for the Copy is assigned. However, setting value may be different between for the Copy and for the Print.

In FIG. 7, for example, when a screen related to the copier function is displayed on the display part 102, this means that an action of reading information of “Setting Information: 01” from the setting information registration part 107 is to be executed.

Thereby, as illustrated in FIGS. 8(A) and 8(B), for example, when the one touch key 103-14 is pressed in a state where a standby screen as a screen related to the copier function is displayed on the display part 102 (see FIG. 8(A)), information of “Setting Information: 01” is read and the information of “Setting Information: 01” is displayed on the display part 102 (see FIG. 8B). As the result, a user can conduct a process with less number of steps with a preferred setting value assigned to the one touch key 103-14.

The one touch key control part 109 selects an assignment action at the time of pressing the one touch key 103-14 corresponding to the display state, referring to the key assignment table of the key assignment part 109 based on display state information upon the receipt of a pressing notification of the one touch key 103-14 and the display state information from the display control part 105.

At this time, the one touch key control part 109 obtains information corresponding to the assignment action at the time of pressing the one touch key 103-14 based on the display state from the destination information registration part 106 and the setting information registration part 107.

Then, the one touch key control part 109 refers to the key assignment table, selects one from the obtained information based on the display state received from the display control part 105, and lets the RAM 117 reflect the selected information and gives the selected information to the display control part 105.

For example, when the one touch key 103-14 is pressed, the one touch control part 109 obtains information related to a process assigned to the one touch key from the destination information registration part 106 and the setting information registration part 107. In a case of the display state information “Scan Menu,” because “Designate Address Book [01]” is assigned as an assignment action as illustrated in the key assignment table of FIG. 7, the one touch key control part 109 selects “Designate Address Book [01]”. The one touch key control part 109 updates a destination designation part of the Scan To Email function memorized in the RAM 117 from “NULL” to “Mail Address of Address Book [01],” and gives “Designate Address Book [01]” to the display control part 105.

Also, upon the repeated receipt of pressing notifications of the one touch key 103-14, the one touch key control part 109 switches an assignment action in a predetermined order.

A switch order of an assignment action when pressing notifications of the one touch key 103-14 are repeatedly received is performed in a predetermined order.

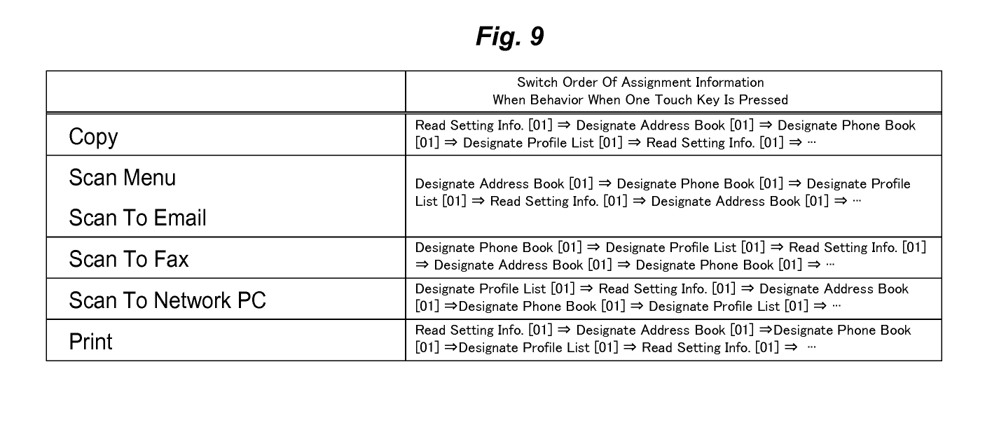

FIG. 9 is an explanatory view that explains an action switch order when the one touch key 103-14 is repeatedly pressed.

For example, when a display state when the one touch key 103-14 is pressed is “Scan Menu,” “Designate Address Book [01] is initially selected. After that, when the second time pressing of the one touch key 103-14 following the first time is pressed, “Designate Phone Book [01]” is selected. Then, when the third time pressing of the one touch key 103-14 following the second time is pressed, “Designate Profile List [01]” is selected. Then, when the fourth time pressing of the one touch key 103-14 following the third time is pressed, “Read Setting Information [01]” is selected. Then, when the fifth time pressing of the one touch key 103-14 following the fourth time is pressed, “Designate Address Book [01]” is selected, returning back to the initial one.

The reading part 110 reads a manuscript and lets the image memory 111 temporarily memorize image data of the read manuscript.

The image memory 111 temporarily memorizes image data.

The image processing part 112 performs a predetermined image process (for example, rotation of image, resolution conversion process, etc.) to image data memorized by the image memory 111 based on a setting content set via the operation panel 101.

The printing part 113 performs a printing process of image based on the image data memorized by the image memory 111 to a medium (for example, sheet, etc.). The printing part 113 may delete the image data memorized by the image memory 111 after completion of printing.

The facsimile transmission part 114 performs transmission of facsimile data to an external apparatus through a communication line such as telephone line based on a predetermined facsimile communication protocol.

The network transmission part 115 performs data transmission to an external apparatus through a telephone line based on a communication protocol such as TCP/IP, for example.

The CPU 116 performs a calculation process following an instruction by the control part 110.

The RAM 117 memorizes information necessary for controlling operations of functions of the image processing apparatus 100.

The ROM 118 memorizes a control program of the image processing apparatus 100.

The control part 119 generally controls an entire function of the image processing apparatus 100.

### Supplemental Definitions

(1) In the invention, the first and second display screens are screens that correspond to several functions, and are configured with several function keys, such as “COPY,” “SCAN MENU, SCAN TO EMAIL,” “SCAN TO FAX,” “SCAN TO NETWORK PC,” and “PRINT.” However, the first display screen has not to be the same as the second display screen.
(2) Also, the first process is defined as a process corresponding to the first display screen, does not necessarily aims to reduce an operation step. The second process is defined as another process corresponding to the second display screen, does not necessarily aim to reduce an operation step. In the same manner, third and fourth processes discussed later are processes that respectively corresponds to the first and second display screens, differing from the other processes.

(A-2) Actions According to First Embodiment

Next, a process action when the one touch key 103-14 of the image processing apparatus 100 according to the first embodiment is pressed is described in detail, referring to the drawings.

(A-2-1) General Flow of Action Selection Control at the Time of Pressing of One Touch Key

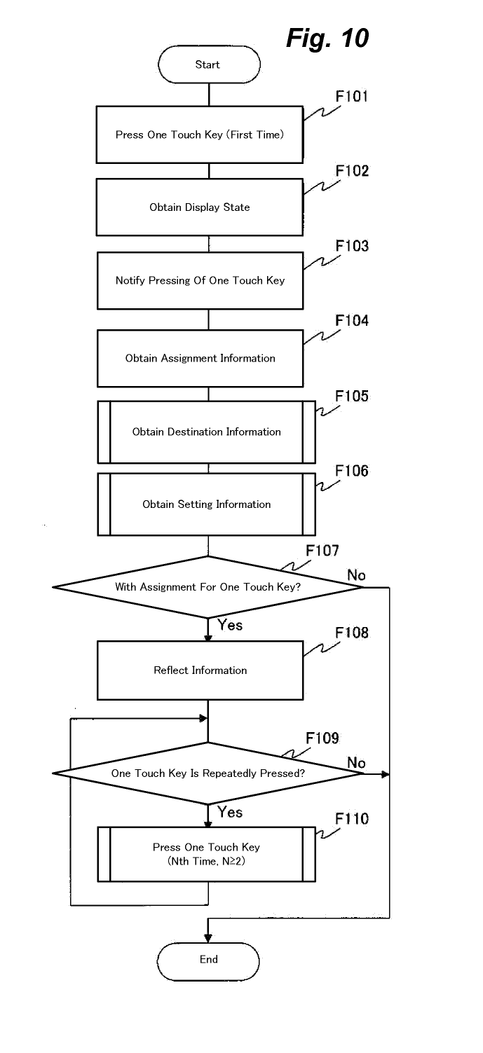

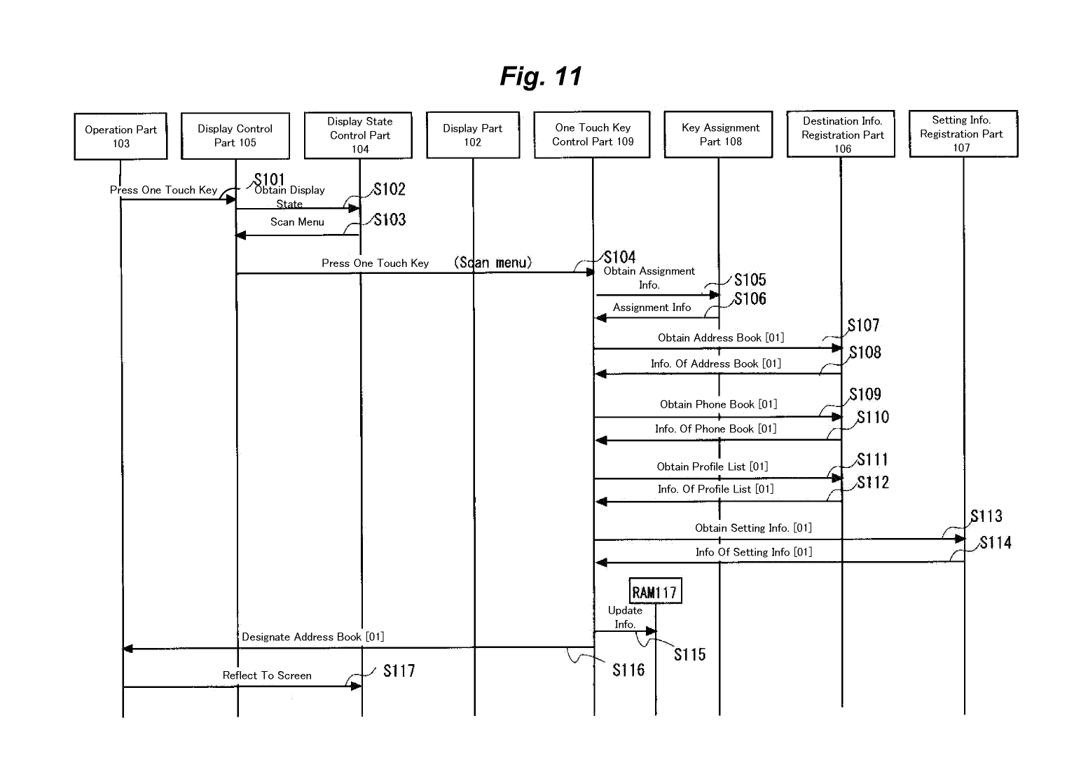

FIG. 10 is a flow diagram that illustrates a process when the one touch key 103-14 in the image processing apparatus 100 is pressed. FIG. 11 is a sequence diagram that illustrates a process when the one touch key 103-14 in the image processing apparatus 100 is pressed.

Note, herein, it is assumed that destination information has already been registered in the first one [01] of the address book, the first one [01] of the phone book, and the first one [01] of the profile list, and setting information has already been registered in the first one [01] of the setting information.

F101: When the one touch key 103-14 of the operation part 103 is pressed, a pressing signal is given to the display control part 105 from the one touch key 103-14 (S101 in FIG. 11).

F102: The display control part 105 performs a request to obtain display state information to the display state management part 104 to obtain a current display state (S102 in FIG. 11), and obtains the current display state of the display part 102 from the display state management part 104 (S103 in FIG. 11).

For example, it is assumed that “Scan Menu” is currently displayed on the display part 102. In this case, the display control part 105 obtains display state information of “Scan Menu” from the display state management part 104. From this, the display control part 105 is able to recognize that the current display state is “Scan Menu”.

F103: The display control part 105 notifies a status that the one touch key 103-14 is pressed and the display state information obtained at F102 to the one touch key control part 109 (S104 in FIG. 11).

F104: The one touch key control part 109 requests for obtaining a key assignment table as assignment information to the key assignment part 108 (S105 in FIG. 11), and, for example, obtains a key assignment table illustrated in FIG. 7 from the key assignment part 108 (S 106 in FIG. 11).

F105-F106: The one touch key control part 109 obtains destination information and setting information related to an action assigned to the one touch key 103-14 from the destination information registration part 106 and the setting information registration part 107, referring to the key assignment table in FIG. 7, for example.

Specifically, as the key assignment table in FIG. 7, to the one touch key 103-14, “Read Setting Information [01],” “Designate Address Book [01],” “Designate Phone Book [01],” and “Designate Profile [01]” are assigned.

The one touch key control part 109 obtains information of the address book [01], information of the phone book [01], information of the profile [01], and information of the setting information [01] from the destination information registration part 106 and the setting information registration part 107.

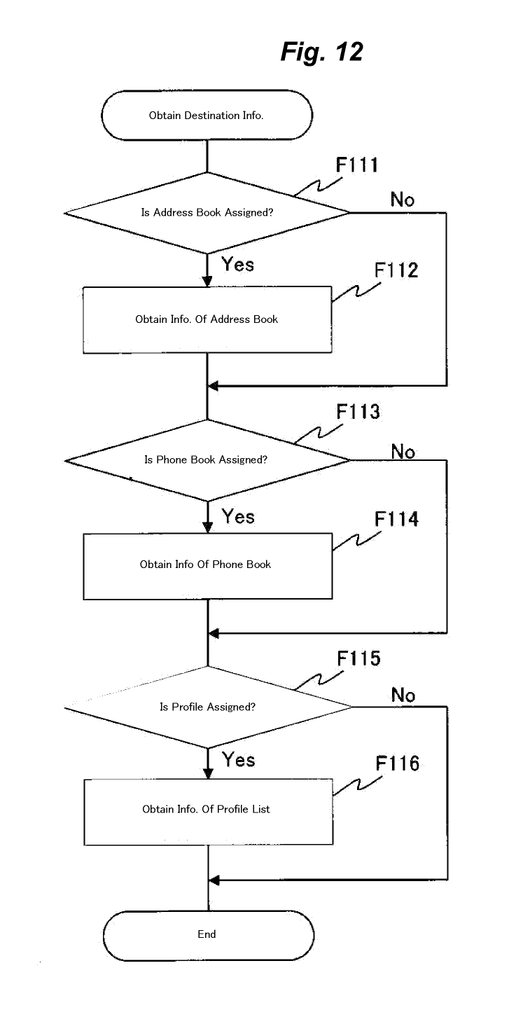

FIG. 12 is a flow diagram that illustrates a obtaining process of destination information. The obtaining process of the destination information is explained using the sequence diagram of FIG. 11 and the flow diagram of FIG. 12.

F111: The one touch key control part 109 performs a request to obtain the address book [01] to the destination information registration part 106, referring to the key assignment table of FIG. 7. If the information of the address book [01] is assigned to the address book of the destination information registration part 106 or not is confirmed.

F112: When the information of the address book [01] is assigned, the one touch key control part 109 obtains the information of the address book [01] (S107 in FIG. 11). On the other hand, when the information of the address book [01] is not assigned, the one touch key control part 109 shifts the process to F113 in FIG. 12.

F113: The one touch key control part 109 performs a request to obtain the phone book [01] to the destination information registration part 106, referring to the key assignment table in FIG. 7 (S109 in FIG. 11). If the information of the phone book [01] is assigned to the phone book of the destination information registration part 106 or not is confirmed.

F114: When the information of the phone book [01] is assigned, the one touch key control part 109 obtains the information of the phone book [01] (S110 in FIG. 11). On the other hand, when the information of the phone book [01] is not assigned, the one touch key control part 109 shifts the process to F115 in FIG. 12.

F115: The one touch key control part 109 performs a request to obtain the profile list [01] to the destination information registration part 106, referring to the key assignment table in FIG. 7 (S111 in FIG. 11). If the information of the profile list [01] is assigned to the profile list of the destination information registration part 106 or not is confirmed.

F116: When the information of the profile list [01] is assigned, the one touch key control part 109 obtains the information of the profile list [01] (S 112 in FIG. 11). On the other hand, when the information of the profile list [01] is not assigned, the one touch key control part 109 ends the process.

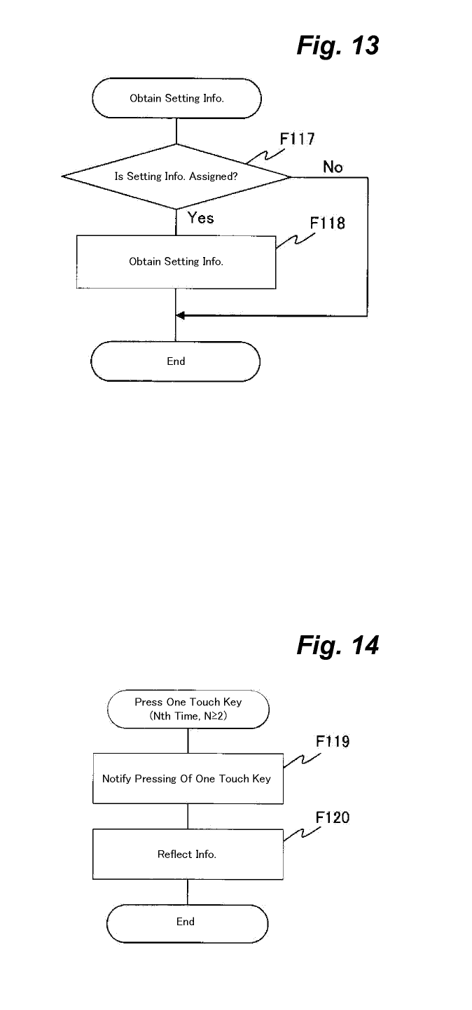

FIG. 13 is a flow diagram that illustrates an obtaining process of setting information. The obtaining process of setting information is explained using the sequence diagram of FIG. 11 and the flow diagram of FIG. 13.

F117: The one touch key control part 109 performs a request to obtain the setting information [01] to the setting information registration part 107, referring to the key assignment table in FIG. 7 (S 113 in FIG. 11). If the information of the setting information [01] is assigned to the setting information registration part 107 or not is confirmed.

F118: When the setting information [01] is assigned, the one touch key control part 109 obtains the information of the setting information [01] (S114 in FIG. 11). On the other hand, when the information of the setting information [01] is not assigned, the one touch key control part 109 ends the process.

F107: The one touch key control part 109 judges if assignment information is assigned to the one touch key 103-14 obtained at F104.

When the assignment information is not assigned to the one touch key 103-14, the one touch key control part 109 notifies the display control part 105 of the status (for example, “NULL”) and ends the process. In this case, the display control part 105 may perform to let the display part 102 display the status that the assignment information is not assigned to the one touch key 103-14, for example.

F108: On the other hand, when the assignment information is assigned to the one touch key 103-14, the one touch key control part 109 selects an assignment action corresponding to a current display state based on the display state information obtained at F103, referring to the key assignment table in FIG. 7. Then, the one touch key control part 109 updates the information related to the selected assignment action in the RAM 117 and lets the RAM 117 reflect it (S 115 in FIG. 11). Furthermore, the one touch key control part 109 notifies the display control part 105 of the information related to the selected assignment action (S 116 in FIG. 11). The display control part 105 displays a screen that reflects the notified information related to the assignment action on the display part 102 (S117 in FIG. 11).

For example, when the display state information is “Scan Menu,” the one touch key control part 109 selects “Designate Address Book [01]” as an assignment action from the key assignment table in FIG. 7. Then, the one touch key control part 109 updates the destination designation part of the Scan To Email function memorized in the RAM 117 from “NULL” to “Mail Address of Address Book [01]”.

Also, the display control part 105 displays a display screen that displays “Mail Address of Address Book [01]” notified from the one touch key control part 109 on the display part 102.

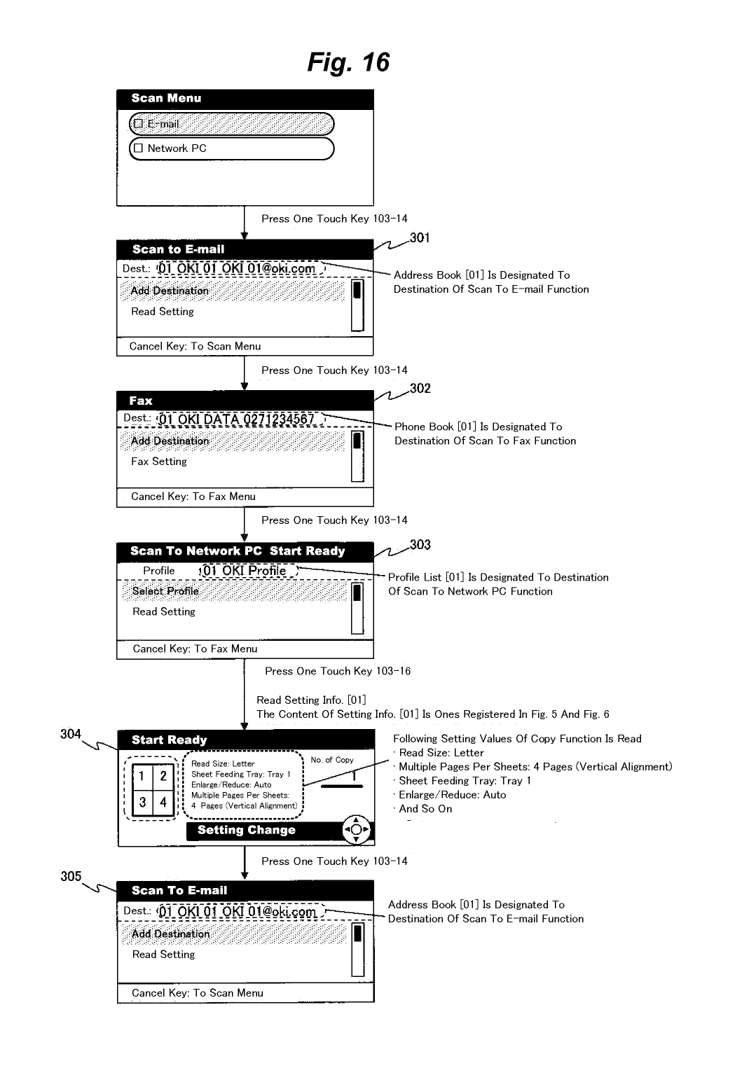

FIGS. 16(A)-16(F) are screen views that illustrate screen examples that are displayed on the display part 102. As a screen 301 in FIG. 16 illustrates, the display control part 105 displays a Scan To E-Mail screen that displays “Mail Address of Address Book [01]” on the display part 102.

F109: The display control part 105 judges if the one touch key 103-14 is repeatedly pressed or not. Then, for example, when the one touch key 103-14 is pressed until a predetermined operation time out occurs, the display control part 105 shifts the process to F110. Also, when an operation key other than the one touch key 103-14 is pressed or a predetermined operation time out occurs, the display control part 105 ends the process.

Note, when the start key 103-6 as an execution key in the operation part 103 is pressed, the image processing apparatus 100 executes a process displayed on the display part 102.

F110: When the one touch key 103-14 is repeatedly pressed several times after a first time pressing of the one touch key 103-14, the display control part 105 performs a switch process of an assignment action in correspondence with the number of times that the one touch key 103-14 is pressed.

(A-2-2) Action Switch Process when One Touch Key is Repeatedly Pressed Several Times

FIG. 14 is a flow diagram that illustrates a switch process of an assignment action when the one touch key 103-14 is repeatedly pressed.

F119: When the display control part 105 receives a pressing notification that the one touch key 103-14 is pressed following a first time pressing, the display control part 105 notifies the one touch key control part 109 of a status that the one touch key 103-14 has been repeatedly pressed.

F120: The one touch key control part 109 performs an update of information related to an assignment action based on the pressing notification of the one touch key 103-14 from the display control part 105, following the switch order in FIG. 9. Then, the one touch key control part 109 gives information related to the assignment action to the display control part 105. The display control part 105 displays a screen that reflects information related to the assignment action obtained from the one touch key control part 109 on the display part 102.

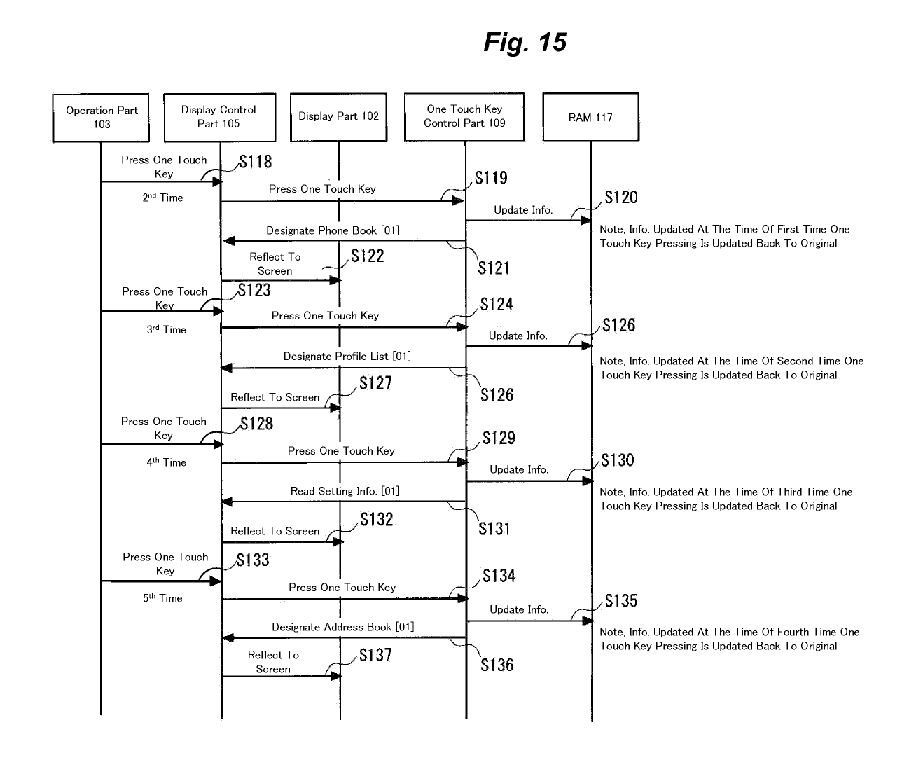

FIG. 15 is a sequence diagram that shows a switch process of an assignment action when the one touch key 103-14 is pressed.

(Second Time One Touch Key 103-14 Pressing)

F101: When the one touch key 103-14 is pressed for a second time following a first time pressing, a pressing signal is notified to the display control part 105 from the one touch key 103-14 (S118).

The display control part 105 notifies the one touch key control part 109 of the second time pressing of the one touch key 103-14 (S119). At this time, because the pressing signal is based on that the one touch key is repeatedly pressed two times, the display control part 105 doesn't notify display state information to the one touch key control part 109.

The one touch key control part 109 switches and selects an assignment action assigned to the one touch key 103-14 following the action switch order in FIG. 9 under a display state at a time of a first one touch key pressing obtained at F103. Then, the one touch key control part 109 updates information memorized in the RAM 117 to information related to a selected assignment action (S120). Also, the one touch key control part 109 notifies the display control part 105 of information related to the selected assignment action (S121).

For example, in FIG. 9, when a display state at the time of first time one touch key pressing is “Scan To Email” and when a second time one touch key pressing is performed, the one touch key control part 109 selects “Designate Phone Book [01]” following the action switch order in FIG. 9. The one touch key control part 109 updates the destination designation part of the Scan To Fax function memorized in the RAM 117 back to “NULL,” and updates the destination designation part of the Scan To NetWorkPC function from “NULL” to “telephone number of phone book [01]”. Then, the one touch key control part 109 gives the selected information of the phone book [01] to the display control part 105.

When the information of “Designate Phone Book [01]” is received, the display control part 105 displays a screen (screen 302 in FIG. 16) on the display part 102 (S122), and shifts to F109. The screen shows that the phone book [01] is designated to a destination of the Scan To Fax function.

(Third Time One Touch Key 103-14 Pressing)

Further, when the one touch key 103-14 is pressed, the display control part 105 executes the process of F110.

The display control part 105 detects that the one touch key 103-14 is pressed immediately after the one touch key 103-14 is pressed for a second time (S123), and notifies the one touch key control part 109 of a status that the one touch key 103-14 has been pressed (S124).

Next, when a display state at the time of first time one touch key pressing is “Scan To Email” and when a third time one touch key pressing is performed, the one touch key control part 109 selects “Designate Profile List [01]” following the action switch order in FIG. 9. The one touch key control part 109 updates the destination designation part of the Scan To Email function memorized in the RAM 117 back to “NULL,” and updates the destination designation part of the Scan To Faxfunction from “NULL” to “Information of Profile List [01]” (S125). Then, the one touch key control part 109 gives the selected information of the “Profile List [01]” to the display control part 105 (S126).

When the information of “Profile List [01]” is received, the display control part 105 displays a screen (screen 303 in FIG. 16) on the display part 102 (S127), and shifts to F109. The screen shows that the profile list [01] is designated to a destination of the Scan To Network PC function.

(Fourth Time One Touch Key 103-14 Pressing)

Further, when the one touch key 103-14 is pressed, the display control part 105 executes the process of F110.

The display control part 105 detects that the one touch key 103-14 is pressed immediately after the one touch key 103-14 is pressed for a third time (S128), and notifies the one touch key control part 109 of a status that the one touch key 103-14 has been pressed (S129).

Next, when a display state at the time of first time one touch key pressing is “Scan To Email” and when a fourth time one touch key pressing is performed, the one touch key control part 109 selects “Read Setting Information [01]” following the action switch order in FIG. 9. The one touch key control part 109 updates the destination designation part of the Scan To Network PC function memorized in the RAM 117 back to “NULL,” and updates to the read setting information (S130). Then, the one touch key control part 109 gives the selected information of the “Read Setting Information [01]” to the display control part 105 (S131).

When the information of “Read Setting Information [01]” is received, the display control part 105 displays a screen (screen 304 in FIG. 16) on the display part 102 (S132), and shifts to F109. The screen shows that a setting is reflected in the read setting information.

(Fifth Time One Touch Key 103-14 Pressing)

Further, when the one touch key 103-14 is pressed, the display control part 105 executes the process of F110.

The display control part 105 detects that the one touch key 103-14 is pressed immediately after the one touch key 103-14 is pressed for a fourth time (S133), and notifies the one touch key control part 109 of a status that the one touch key 103-14 has been pressed (S134).

Next, when a display state at the time of first time one touch key pressing is “Scan To Email” and when a fifth time one touch key pressing is performed, the one touch key control part 109 selects “Read Address Book [01]” following the action switch order in FIG. 9. The one touch key control part 109 updates the setting item of the setting information [01] memorized in the RAM 117 back to the original setting value, and updates to the destination designation part of the Scan To Email function from “NULL” to “Mail Address of Address Book [01]” (S135). Then, the one touch key control part 109 gives the selected information of the “Designate Address Book [01]” to the display control part 105 (S136).

When the information of “Designate Address Book [01]” is received, the display control part 105 displays a screen (screen 306 in FIG. 16) on the display part 102 (S137), and shifts to F109. The screen shows that a mail address of the address book [01] is designated to the destination of the Scan To Email function.

Also in a procedure for a sixth or subsequent time pressing, the process the same as the above-described process is repeatedly performed.

(A-3) Effect of First Embodiment

As described above, according to the first embodiment, plural processes assigned to an operation key can be switched and selected in correspondence with a display state of the display part.

### (B) Second Embodiment

Next, an image processing apparatus according to a second embodiment of the present invention is explained in detail, referring to the drawings.

Also in the second embodiment, as in the first embodiment, a form in a case where the present invention is applied to a multifunction peripheral (MFP) that includes plural functions is described.

(B-1) Configuration of Second Embodiment

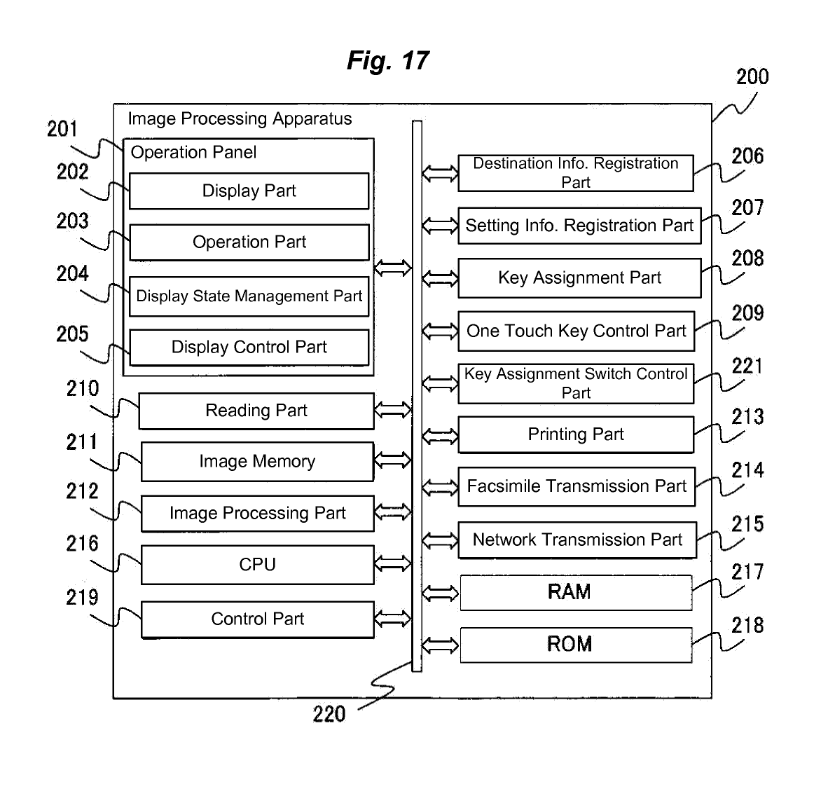

FIG. 17 is a configuration view that illustrates a configuration of the image processing apparatus according to the second embodiment.

In FIG. 17, an image processing apparatus 200 according to the second embodiment includes an operation panel 201, a destination information registration part 206, a setting information registration part 207, a key assignment part 208, a one touch control part 209, a reading part 210, an image memory 211, an image processing part 212, a printing part 213, a facsimile transmission part 214, a network transmission part 215, an CPU 216, a RAM 217, a ROM 218, and a control part 219, and a key assignment switch control part 221.

The image processing apparatus 200 according to the second embodiment includes the key assignment switch control part 221 in addition to the elements that the image processing apparatus 100 according to the first embodiment in FIG. 1 includes. Therefore, the second image processing apparatus 200 according to the second embodiment can achieve the same processes as or corresponding processes to the processes of the image processing apparatus 100 explained in the first embodiment.

Hereinafter, configurations and processes that are different from the ones of the image processing apparatus 100 according to the first embodiment are mainly explained.

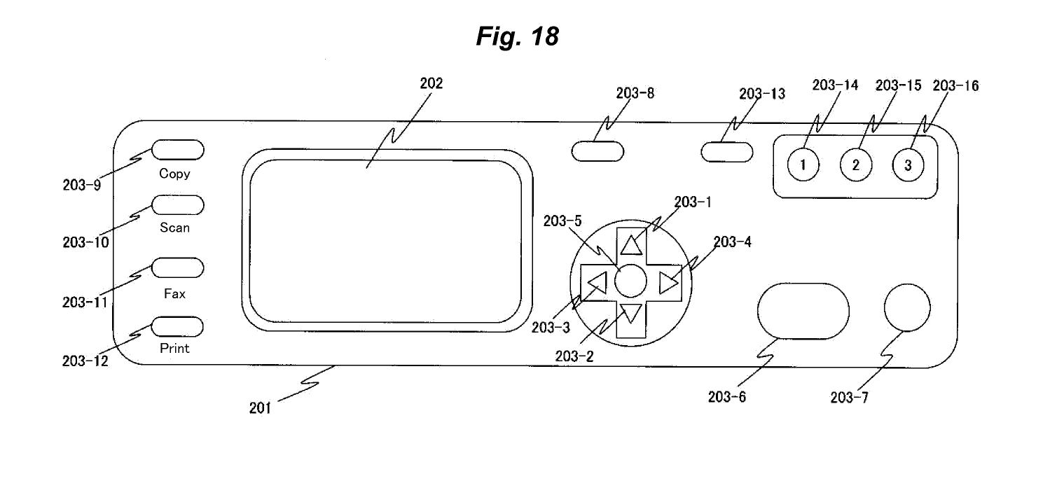

FIG. 18 is an appearance configuration view that illustrates an appearance configuration of the operation panel 201 according to the second embodiment.

In FIG. 18, the operation part 203 in the operation panel 201 includes an up key 203-1, a down key 203-2, a left key 203-3, a right key 203-4, a determination key 203-5, a start key 203-6, a cancel key 203-7, a device setting key 203-8, a copier key 203-9, a scanning function key 203-10, a facsimile key 203-11, a printing key 203-12, a setting information registration key 203-13, and plural number of pieces of one touch keys 203-14, 203-15, and 203-16 (second or subsequent one touch key may be referred to as a second operation key).

Note, in FIG. 13, a case that three pieces of one touch keys are provide is shown as an example. However, the operation part 203 that includes plural number of pieces of one touch keys is applicable, and the plural number may be two or four.

In addition to the functions according to the first embodiment, when the one touch keys 203-14, 203-15, and 203-16 of the operation part 203 are pressed, the display control part 205 obtains a current display state information from the display state management part 204, and notifies a one touch key control part 209 that is described below of the obtained display state information and a status that the one touch key is pressed. Also, the display control part 205 updates a display state managed by the display state management part 204 when behavior information (assignment action information) with respect to one touch key pressing is received from the one touch key control part 209.

The key assignment part 208 assigns information registered in the destination information registration part 206 and the setting information registration part 207 (the destination information registration part 206 and the setting information registration part 207 may collectively be referred to as a memory part) to the respective one touch keys 203-14, 203-15, and 203-16.

The key assignment part 208 manages a display state of the display part 202 when the respective one touch keys 203-14, 203-15, and 203-16 are pressed, and a behavior (action) to be executed after pressing of the respective one touch keys 203-14, 203-15, and 203-16.

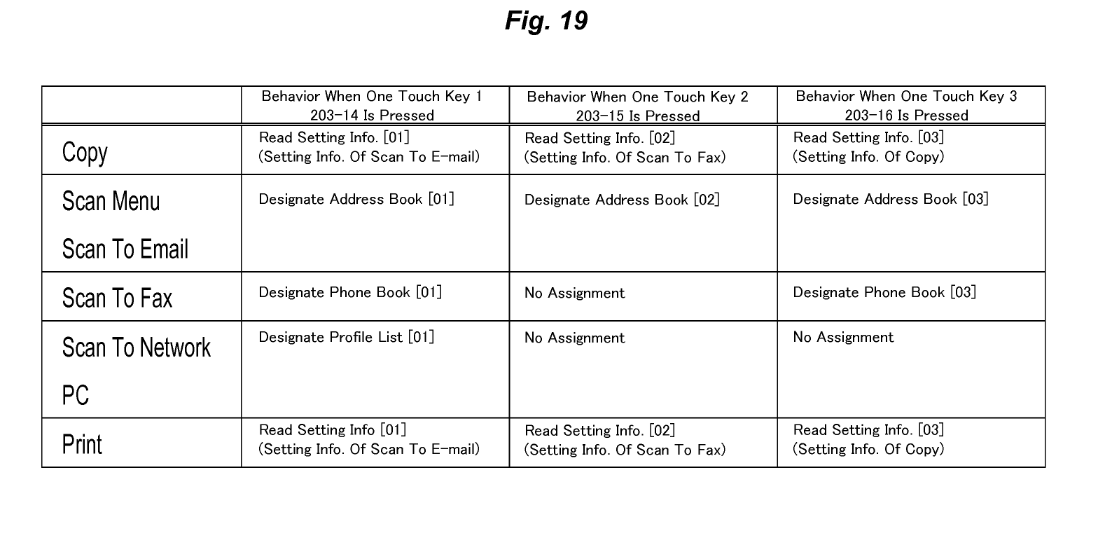

FIG. 19 is a configuration view that illustrates a configuration of a key assignment table as assignment information of the key assignment part 208.

In the key assignment table in FIG. 19, one or plural actions are assigned to each of the one touch keys 203-14, 203-15, and 203-16. Also in the key assignment table in FIG. 19, an action to start is assigned based on a current display state of the display part 202, “Display State” and “Behavior When One Touch Key Is Pressed” are corresponded.

In addition to the functions according to the first embodiment, the one touch key control part 209 notifies the key assignment switch control part 221 of one touch key classification information, information of whether the same one touch key is repeatedly pressed or two or more different one touch keys are pressed in raw when the one touch key is repeatedly pressed, and the display state information when the one touch key is pressed for a first time.

Also, the one touch key control part 209 notifies the key assignment switch control part 221 of the assignment information of the one touch keys. Furthermore, the one touch key control part 209 obtains switch information of the one touch key assignment from the key assignment switch control part 221, and lets the RAM 217 reflect the information.

Note, at the time of reflecting, the previous information is deleted. However, when the display state is “Scan To E-mail” or “Scan To Fax” and when ‘Designate Address Book” or “Designate Phone Book” is obtained, a destination is added. To do so, in that case, the reflection is performed as the previous reflected information remains in the RAM 217.

Upon the obtaining of one touch key pressing notification from the one touch key control part 209, the key assignment switch control part 221 selects a behavior of the one touch key from information related to the one touch key and the display state information, which are obtained simultaneously, and assignment information of the one touch key, and gives the one to the one touch key control part 209.

Also, the key assignment switch control part 221 selects an assignment based on the action switch order in FIG. 9 when the one touch key is repeatedly pressed.

Furthermore, the key assignment switch control part 221 requests the display control part 205 to display a message that no information is registered on the display part 202 when information related to the selected action is not registered in the destination information registration part 206 or the setting information registration part 207. For example, it may be arranged to display the message that no information is registered on the display part 202 for a predetermined period of time (for example, three seconds, etc.), and it may also be arranged to display a screen that includes the message that no information is registered on the display part 202.

(B-2) Actions According to Second Embodiment

Next, a process action when the one touch keys of the image processing apparatus 200 according to the second embodiment are pressed is described in detail, referring to the drawings.

(B-2-1) General Flow of Action Selection Control at the Time of Pressing of One Touch Keys

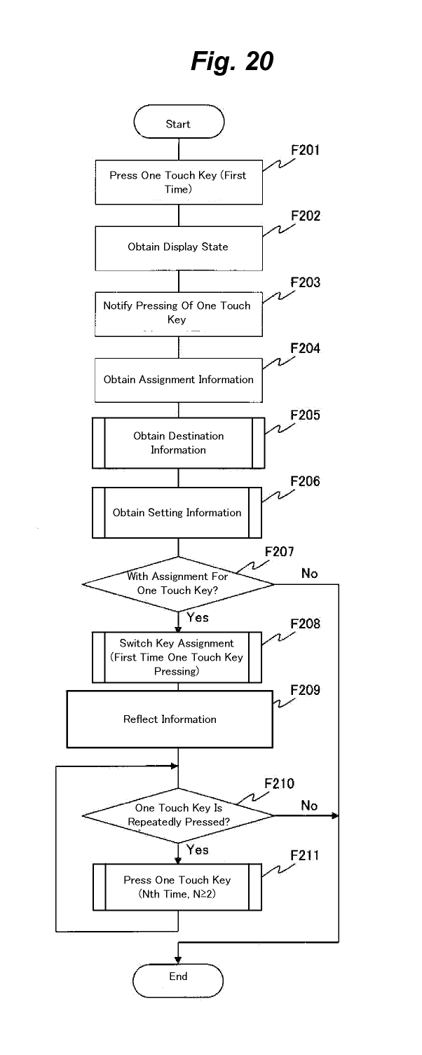

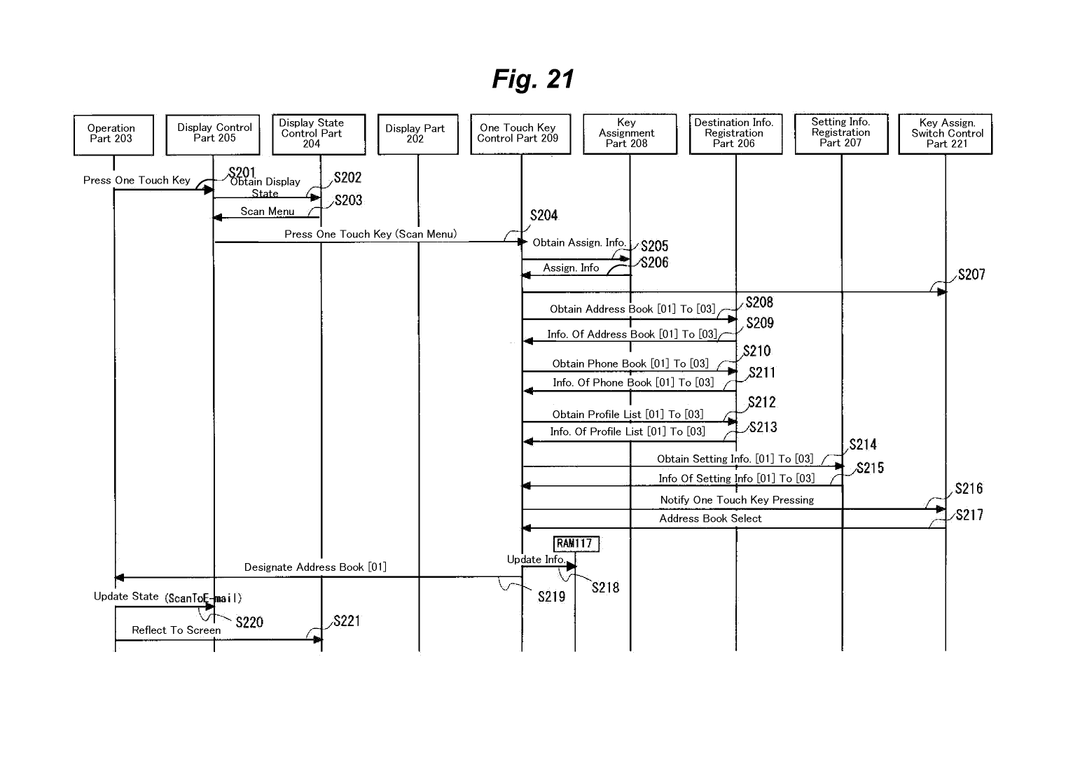

FIG. 20 is a flow diagram that illustrates a process when the one touch keys in the image processing apparatus 200 are pressed. FIG. 21 is a sequence diagram that illustrates a process when the one touch keys in the image processing apparatus 200 are pressed.

Note, herein, it is assumed that destination information has already been registered in the first one [01], second one [02] and third one [03] of the address book, the first one [01] and third one [03] of the phone book, and the first one [01] of the profile list, and setting information has already been registered in the first one [01], second one [02] and third one [03] of the setting information.

Also as illustrated in FIG. 19, it is assumed that the first ones are assigned to the one touch key 103-14, the second ones are assigned to the one touch key 103-15, and the third ones are assigned to the one touch key 103-16.

F101: When the one touch key 203-14 of the operation part 203 is pressed, a pressing signal is given to the display control part 205 from the one touch key 203-14 (S201 in FIG. 21).

F202: The display control part 205 performs a request to obtain display state information to the display state management part 204 to obtain a current display state (S202 in FIG. 21), and obtains information that indicates the current display state of the display part 202 from the display state management part 204 (S203 in FIG. 21). For example, “Scan Menu” is displayed on the display part 202, and then the display control part 205 obtains display state information of “Scan Menu”.

F203: The display control part 205 notifies the one touch key control part 209 of a status that the one touch key 203-14 is pressed and the display state information of “Scan Menu” obtained at F202 (S204 in FIG. 21).

F204: The one touch key control part 209 obtains assignment information of each of the one touch keys, which is illustrated in FIG. 19, from the key assignment part 208 (S205 and S206 in FIG. 21), and gives the assignment information to the key assignment switch control part 221 (S207 in FIG. 21).

F205: The one touch key control part 209 obtains the destination information from the destination information registration part 206 (S208-S213 in FIG. 21). Herein, the destination information related to the actions assigned to all of the one touch keys 203-14, 203-15 and 203-16 set in the key assignment table in FIG. 19 are obtained from the destination information registration part 206. For the method of obtaining the destination information, the same method as in the first embodiment is applicable so that detail explanation herein is omitted.

F206: The one touch key control part 209 obtains the setting information from the setting information registration part 207 (S214 and S215 in FIG. 21). Herein, the setting information related to the actions assigned to all of the one touch keys 203-14, 203-15 and 203-16 set in the key assignment table in FIG. 19 are obtained from the setting information registration part 207. For the method of obtaining the setting information, the same method as in the first embodiment is applicable so that detail explanation herein is omitted.

F207: The one touch key control part 209 judges if assignment information is assigned to the one touch keys 203-14, 203-15 and 203-16 obtained at F204.

When the assignment information is not assigned to the one touch key 203-14 that is currently pressed (in other words, in the case of “NULL”), the one touch key control part 209 notifies the display control part 205 of the status (for example, “NULL”) and ends the process. In this case, the display control part 205 may perform to let the display part 202 display the status that the assignment information is not assigned to the one touch key 203-14, for example.

F208: When the assignment information is assigned to the one touch key 203-14, the one touch key control part 209 gives information that combines the one touch key classification information and the display state information obtained at F202 as a one touch key pressing notification to the key assignment switch control part 221 (S216 in FIG. 21).

Then, the key assignment switch control part 221 selects an assignment action based on the obtained one touch key classification information and the display state information (in this case, the address book [01] is selected). Furthermore, the key assignment switch control part 221 gives the one touch key control part 209 the information related to the selected assignment action (S217 in FIG. 21).

Note, a selection process of assignment actions by the key assignment switch control part 221 is described below in detail.

F209: The one touch key control part 209 updates the destination designation part of the Scan To Email function memorized in the RAM 217 from “NULL” to “Mail Address of Address Book [01]” based on the information of the display state obtained at F202, the assignment information obtained at F204, and the assignment action of the one touch key selected at F208 (S218 in FIG. 21).

Then, the one touch key control part 209 notifies the display control part 205 of the information of “Designate Address Book [01]” obtained at F205 (S219 in FIG. 21).

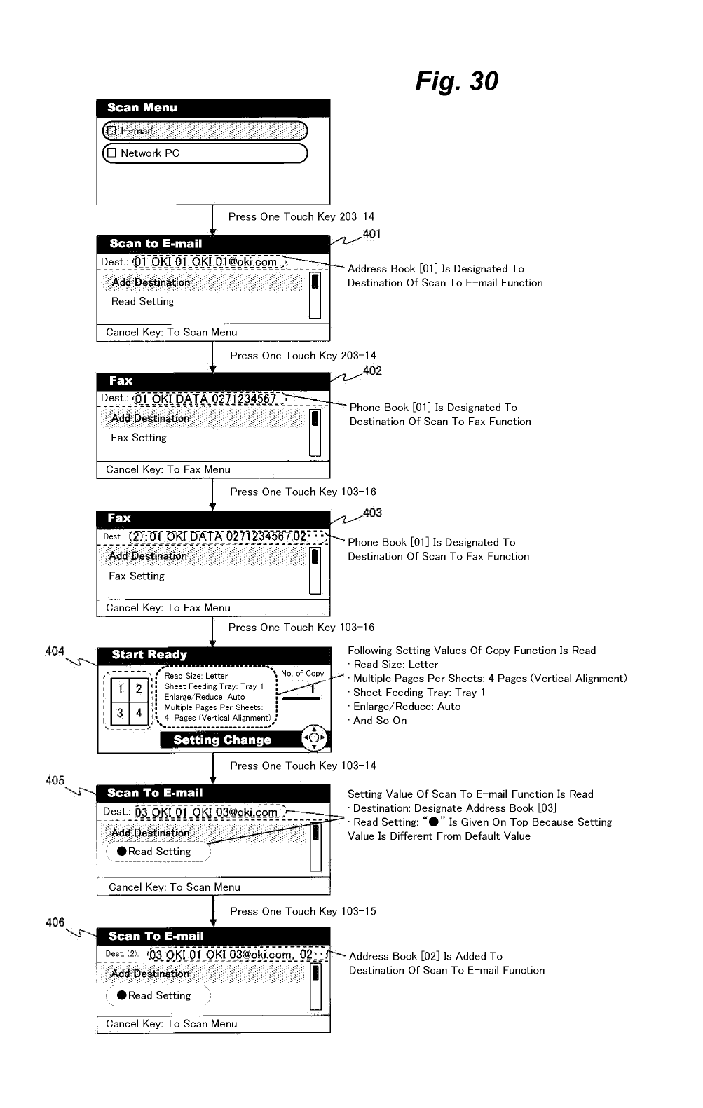

When the information of “Designate Phone Book [01]” is received, the display control part 205 updates the display state of the display state management part 204 to “Scan To E-mail” (S220 in FIG. 21), and displays a screen (screen 401 in FIG. 30(B)) on the display part 202 (S221 in FIG. 21). The screen shows that the address book [01] is designated to a destination of the Scan To E-mail function.

F210: The display control part 205 judges if the one touch keys 203-14, 203-15, and 203-16 are repeatedly pressed or not. Then, for example, when either one of the one touch keys 203-14, 203-15, and 203-16 is pressed until a predetermined operation time out occurs, the display control part 205 shifts the process to F211. Also, when an operation key other than the one touch keys 203-14, 203-15, and 203-16 is pressed, when a predetermined operation time out occurs, or when it is judged that nothing is assigned to the one touch keys, the display control part 205 ends the process.

F211: When the one touch keys 203-14, 203-15, and 203-16 are pressed immediately after that the one touch key 203-14 is pressed for a first time, the display control part 205 detects the one touch key classification to recognize which one of the one touch keys 203-14, 203-15, and 203-16 is pressed. Then, the display control part 205 performs the switch process of the assignment action based on the one touch key classification and the number of times that the one touch keys are pressed.

Note, an action selection process when the one touch keys are repeatedly pressed several times is described below.

(B-2-2) Action Selection Process in Key Assignment Switch Control Part 221 at the Time of First Time Pressing of One Touch Key

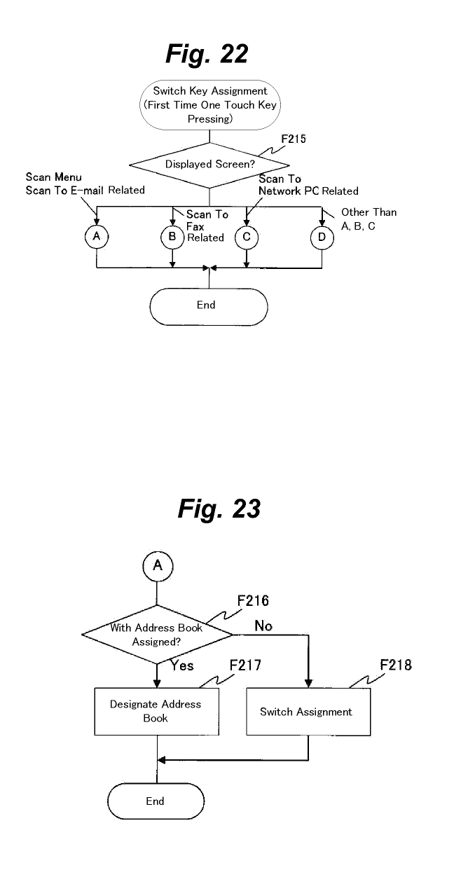

FIGS. 22-26 are flow diagrams that illustrate an action selection process in the key assignment switch control part 221 at the time of a first time pressing of the one touch key.

At F208 in FIG. 20, the key assignment switch control part 221 obtains combined information of the one touch key classification information and the display state information obtained at F202 as a one touch key pressing notification from the one touch key control part 209.

F215: The key assignment switch control part 221 judges a current display state of the display part 202 based on the obtained display state information.

For example, the key assignment switch control part 221 shifts the process to F216 in FIG. 23 when the display state information is “Scan Menu” or “Scan To E-mail”.

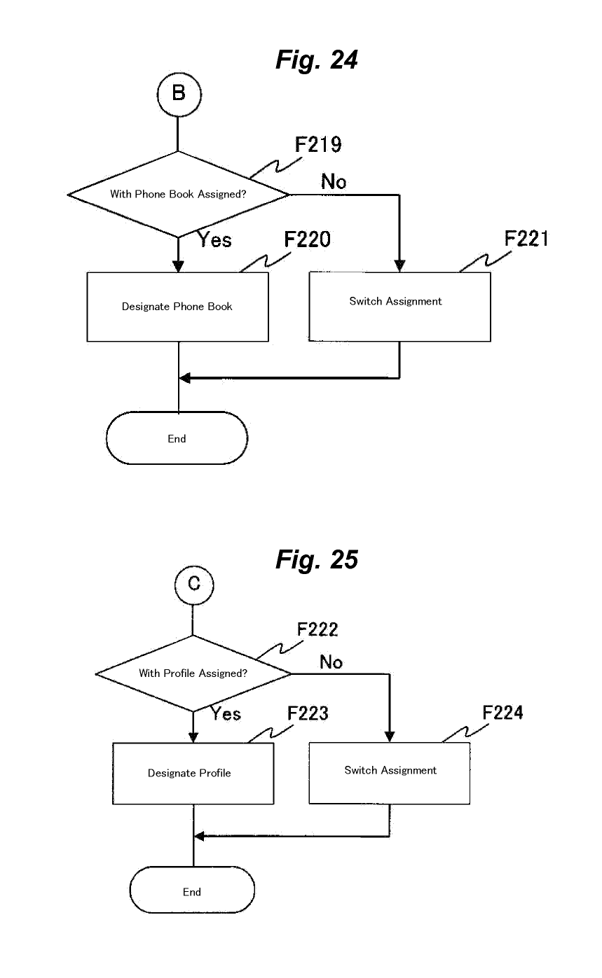

Also for example, when the display state information is “Scan To Fax,” the key assignment switch control part 221 shifts the process to F219 in FIG. 24, and when the display state information is “Scan To Network PC,” the key assignment switch control part 221 shifts the process to F222 in FIG. 25.

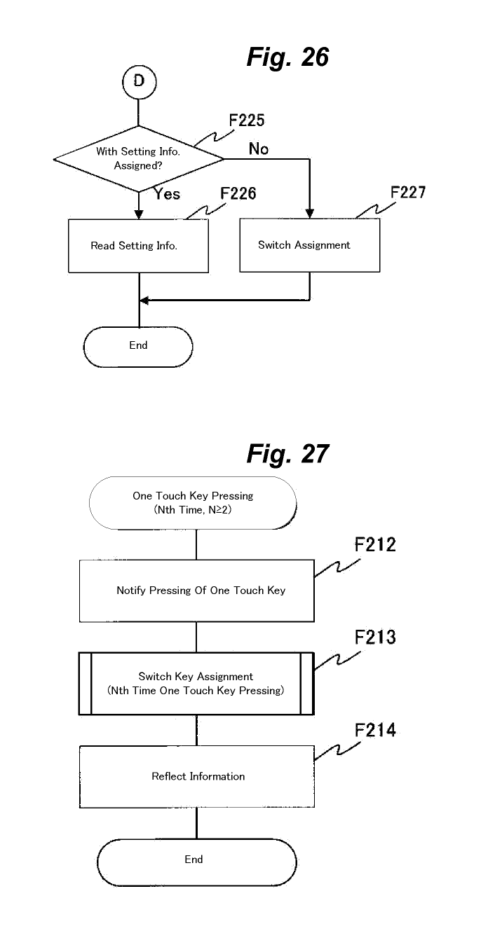

Also for example, when the display state information is one other than “Scan Menu,” “Scan To E-Mail,” “Scan To Fax,” and “Scan To Network PC,” the key assignment switch control part 221 shifts the process to F225 in FIG. 26.

F216: The key assignment switch control part 221 confirms if the address book corresponding to the display state “Scan Menu” or “Scan To E-mail” is assigned to the one touch key based on the one touch key classification information at the time of first pressing of one touch key, referring to the key assignment table in FIG. 19.

When the address book is assigned, the key assignment switch control part 221 shifts the process to F217, and when the address book is not assigned, the key assignment switch control part 221 shifts the process to F218.

F217: When the address book is assigned, the key assignment switch control part 221 selects “Designate Address Book” that is assigned, and notifies the one touch key control part 209 of the selected “Designate Address Book”.

For example, when the one touch key 203-14 is pressed for a first time, the key assignment switch control part 221 selects the “Designate Address Book [01],” referring to the key assignment table in FIG. 19, and notifies the one touch key control part 209 of the information.

F218: When the address book is not assigned, the key assignment switch control part 221 switches to other assignment information assigned to the one touch key 203-14, referring to the key assignment table in FIG. 19. As a method to switch to the other assignment information, for example, the key assignment switch control part 221 may switch assignment information following the action switch order in FIG. 9.

For example, in FIG. 19, when the address book corresponding to “Scan Menu” or “Scan To E-Mail” is not assigned to the one touch key 203-14, the key assignment switch control part 221 performs an action switch following the action switch order in FIG. 9, and selects a next “Designate Phone Book [01]” as other assignment information.

As a result, even when the assignment information corresponding to the display state “Scan Menu” or “Scan To E-Mail” is not set, another action assigned to the one touch key 203-14 can be displayed to a user, so that user convenience can be improved.

Note, herein, a case that the other assignment information is selected is explained. However, the key assignment switch control part 221 may notify the one touch key control part 209 of that the corresponding assignment information is not set, and the display control part 205 performs a display control to temporarily display a screen that indicates that no corresponding assignment information exists on the display part 202 and then to change the screen to a screen including the other assignment information.

F219: The key assignment switch control part 221 confirms if a phone book corresponding to the display state “Scan To Fax” is assigned to the one touch key based on the classification information of the one touch key at the time of pressing of the one touch key, referring to the key assignment table in FIG. 19.

When the phone book is assigned, the key assignment switch control part 221 shifts the process to F220, and when the phone book is not assigned, the key assignment switch control part 221 shifts the process to F221.

F220: When the phone book is assigned, the key assignment switch control part 221 selects the assigned “Designate Phone Book,” and notifies the one touch key control part 209 of the selected “Designate Phone Book”.

F221: When the phone book is not assigned, the key assignment switch control part 221 switches to other assignment information assigned to the one touch key 203-14, referring to the key assignment table in FIG. 19. To the method to switch to the other assignment information, the process the same as the process at F218 can be used.

F222: The key assignment switch control part 221 confirms if a profile list corresponding to the display state “Scan To NetworkPC” is assigned to the one touch key based on the classification information of the one touch key at the time of pressing of the one touch key, referring to the key assignment table in FIG. 19.

When the profile list is assigned, the key assignment switch control part 221 shifts the process to F223, and when the profile list is not assigned, the key assignment switch control part 221 shifts the process to F224.

F223: When the profile list is assigned, the key assignment switch control part 221 selects the assigned “Designate Profile List,” and notifies the one touch key control part 209 of the selected “Designate Profile List”.

F224: When the profile list is not assigned, the key assignment switch control part 221 switches to other assignment information assigned to the one touch key 203-14, referring to the key assignment table in FIG. 19. To the method to switch to the other assignment information, the process the same as the process at F218 can be used.

F225: When the display state is “Copy” of “Print” for example, the key assignment switch control part 221 confirms if setting information corresponding to the display state “Copy” of “Print” is assigned to the one touch key based on the classification information of the one touch key at the time of pressing of the one touch key, referring to the key assignment table in FIG. 19.

When the setting information is assigned, the key assignment switch control part 221 shifts the process to F226, and when the setting information is not assigned, the key assignment switch control part 221 shifts the process to F227.

F226: When the profile information is assigned, the key assignment switch control part 221 selects the assigned “Designate Setting Information,” and notifies the one touch key control part 209 of the selected “Designate Setting Information”.

F227: When the setting information is not assigned, the key assignment switch control part 221 switches to other assignment information assigned to the one touch key 203-14, referring to the key assignment table in FIG. 19. To the method to switch to the other assignment information, the process the same as the process at F218 can be used.

(B-2-3) Action Switch Process when One Touch Key is Repeatedly Pressed Several Times

Next, a action switch process when the one touch keys are repeatedly pressed several times is described in detail, referring to the drawings.

FIG. 27 is a flow diagram that illustrates the action selection process when the one touch key according is repeatedly pressed several times.

At F211 in FIG. 20, when one of the one touch keys 203-14, 203-15, and 203-16 is pressed immediately after the pressing of the one touch key 203-14, the display control part 205 detects the classification of the one touch key and the number of times that the one touch key is pressed, and obtains display state information from the display state management part 204.

F212: Upon the repeated pressing of the one touch key for a second or subsequent time, the display control part 205 notifies the one touch key control part 209 of the classification of the one touch key, the number of times that the one touch key is pressed, and the display state information.

F213: The one touch key control part 209 notifies the key assignment switch control part 221 of the classification of the one touch key, information that indicates if the pressed one touch keys are the same or different, the display state information. The key assignment switch control part 221 selects an assignment action corresponding to the current pressing of the one touch key based on the classification of the one touch key, referring to the key assignment table in FIG. 19. Then, the key assignment switch control part 221 notifies the one touch key control part 209 of the selected assignment action.

Note, a detail explanation of a action selection process by the key assignment switch control part 221 at the time of pressing of one touch key for N (N≧2) or subsequent time is given later.

F214: Then, the one touch key control part 109 updates information memorized in the RAM 217 based on the display state information obtained at F212, the assignment information obtained at F204, and the action of the one touch key selected at F213. Then, the one touch key control part 209 notifies the display control part 205 of information related to the selected action, and the display control part 205 displays a screen that reflects the obtained information related to the action on the display part 202.

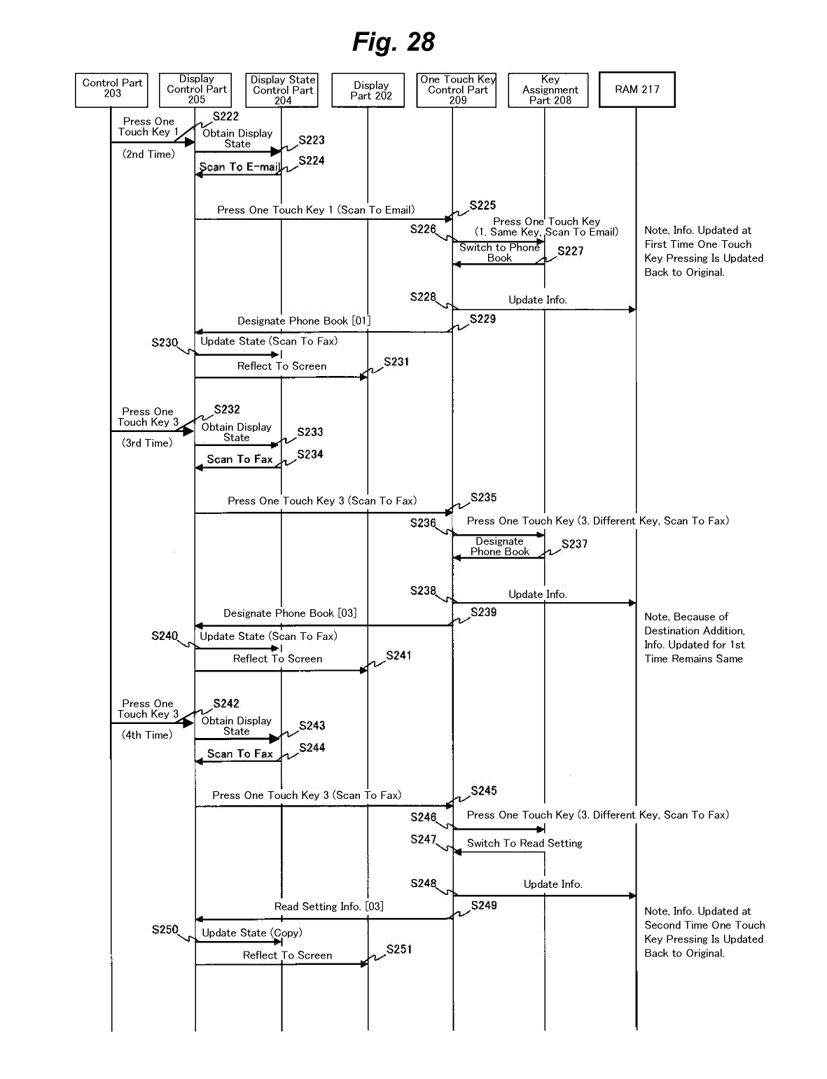

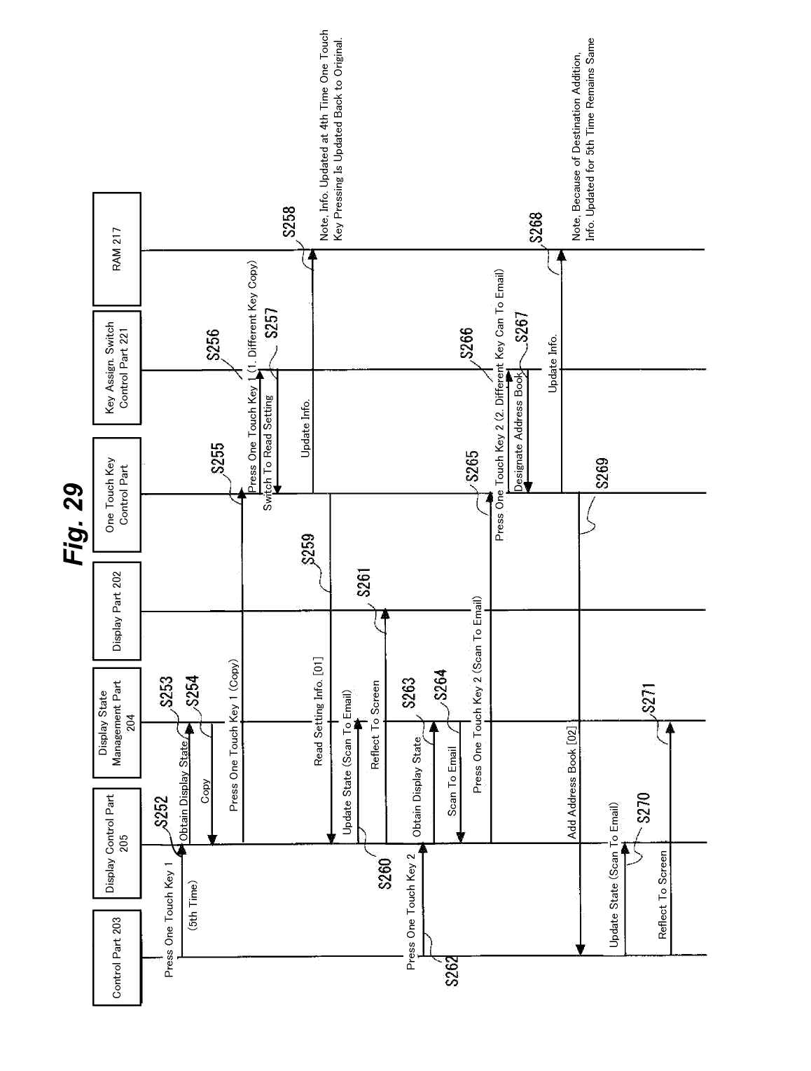

FIG. 28 and FIG. 29 are sequence diagrams that illustrate the action switch process when the one touch key is repeatedly pressed several times. Also, FIG. 30 is an explanatory view that explains screen transition of the display part 202 when the one touch key is repeatedly pressed several times.

Herein, a detail explanation is given using an example that the one touch key 203-14 is pressed for a second time, the one touch key 203-16 is pressed for a third time, the one touch key 203-16 is pressed for a fourth time, the one touch key 203-14 is pressed for a fifth time, and the one touch key 203-15 is pressed for a sixth time.

(Second Time One Touch Key Pressing)

When a pressing signal is notified from the one touch key 203-14 to the display control part 205 (S222), the display control part 205 performs a request to obtain display state information to the display state management part 204 (S223), and the display state management part 204 gives the display state information to the display control part 205 (S224).

For example, when a screen 401 in FIG. 30 is displayed on the display part 202, because a current display state thereof is “Scan To E-Mail,” display state information of “Scan To E-Mail” is given to the display control part 205.

The display control part 205 gives the classification [1] of the one touch key 203-14 and the display state information “Scan To E-Mail” to the one touch key control part 209 (S225).

The one touch key control part 209 notifies the key assignment switch control part 221 of the classification [1] of the one touch key 203-14, information that the same key is pressed, and the display state information “Scan To E-Mail” (S226).

The key assignment switch control part 221 specifies a corresponding action (see “Designate Address Book” in FIG. 19) based on the display state information “Scan To E-Mail” and the classification of a currently pressed one touch key (one touch key 203-14 herein), referring to the key assignment table in FIG. 19.

Then, because the currently pressed one touch key is the same as the previously pressed key, the key assignment switch control part 221 performs action switch following the action switch order in FIG. 9 and selects “Designate Phone Book” from the above-described specified action “Designate Address Book”.

The key assignment switch control part 221 notifies the switch to the selected action “Designate Phone Book” (S227), and the one touch key control part 209 updates the destination designation part of the Scan To FAX function memorized in RAM 217 from “NULL” to “Information of Phone Book [01]” (S228).

Also, the one touch key control part 209 notifies the display control part 205 of the information of “Designate Phone Book [01]” (S229).

The display control part 205 updates the display state of the display state management part 204 to “Scan To Fax” upon the receipt of information of “Designate Address Book [01]” (S230), and displays a screen (screen 402 in FIG. 30) that indicates that the phone book [01] has been designated as a destination of the Scan To Fax function is displayed on the display part 202 (S231).

(Third Time One Touch Key Pressing)

When the one touch key 203-16 is pressed and a pressing signal is notified from the one touch key 203-16 to the display control part 205 (S232), the display control part 205 performs a request to obtain display state information to the display state management part 204 (S233), and the display state management part 204 gives the display state information to the display control part 205 (S234).

For example, when a screen 402 in FIG. 30 is displayed on the display part 202, because a current display state thereof is “Scan To Fax,” display state information of “Scan To Fax” is given to the display control part 205.

The display control part 205 gives the classification [3] of the one touch key 203-16, information that a different key is pressed, and the display state information “Scan To Fax” to the one touch key control part 209 (S235).

The one touch key control part 209 notifies the key assignment switch control part 221 of the classification [3] of the one touch key 203-16, information that the same key is pressed, and the display state information “Scan To Fax” (S236).

The key assignment switch control part 221 specifies a corresponding action (see “Designate Phone Book” in FIG. 19) based on the display state information “Scan To Fax” and the classification of a currently pressed one touch key (one touch key 203-16 herein), referring to the key assignment table in FIG. 19.

Then, because the currently pressed one touch key is different from the previously pressed key, the key assignment switch control part 221 selects the above-described specified action “Designate Phone Book”.

The key assignment switch control part 221 notifies the switch to the selected action “Designate Phone Book” (S237), and the one touch key control part 209 performs update and adds “Information of Phone Book [03] to the destination designation part of the Scan To FAX function memorized in RAM 217 (S238).

At this time, because the display state is “Scan To Fax” that is the same as the one for the previous (second) time, the one touch key control part 209 keeps the destination information designated in the previous (second) time in the RAM 217, and adds a destination designated in this time to the RAM 217. As a result, it is possible to perform facsimile communication to two destinations that are designated in the second and third time.

Also, the one touch key control part 209 notifies the display control part 205 of the information of “Designate Phone Book [03]” (S239).

The display control part 205 updates the display state of the display state management part 204 to “Scan To Fax” upon the receipt of information of “Designate Phone Book [03]” (S240), and displays a screen (screen 403 in FIG. 30) that indicates that the phone book [03] has been designated as a destination of the Scan To Fax function is displayed on the display part 202 (S241).

On the screen 403 in FIG. 30, two destinations are displayed as destination information of “Scan To Fax”. Herein, for example, a “Delete” key may be provided as an operation key or on the screen 403, which deletes the destination. As a result, destination information that is incorrectly selected can be deleted.

(Fourth Time One Touch Key Pressing)

Furthermore, when the one touch key 203-16 that is the same one as the one pressed for the previous time (third time) is pressed and a pressing signal is notified from the one touch key 203-16 to the display control part 205 (5242), the display control part 205 performs a request to obtain display state information to the display state management part 204 (S243), and the display state management part 204 gives the display state information to the display control part 205 (S244).

For example, when a screen 403 in FIG. 30 is displayed on the display part 202, because a current display state thereof is “Scan To FAX,” display state information of “Scan To FAX” is given to the display control part 205.

The display control part 205 gives the classification [3] of the one touch key 203-16 and the display state information “Scan To FAX” to the one touch key control part 209 (S245).

The one touch key control part 209 notifies the key assignment switch control part 221 of the classification [3] of the one touch key 203-16, information that the same key has been pressed, and the display state information “Scan To FAX” (S246).

The key assignment switch control part 221 specifies a corresponding action (see “Designate Phone Book” in FIG. 19) based on the display state information “Scan To FAX” and the classification of a currently pressed one touch key (one touch key 203-16 herein), referring to the key assignment table in FIG. 19.

Then, because the currently pressed one touch key is the same as the previously pressed key, the key assignment switch control part 221 performs action switch following the action switch order in FIG. 9 from the above-described specified action “Designate Phone Book”. At this time, as illustrated in FIG. 19, because an action corresponding to “Scan To NetworkPC” of the one touch key 203-16 has not been assigned, the key assignment switch control part 221 switches to an action after the next, and selects “Read Setting Information (setting information for Copy)”.

The key assignment switch control part 221 notifies the switch to the selected action “Read Setting Information” (S247), and the one touch key control part 209 updates to the setting information [03] memorized in RAM 217 (S248).

Also, the one touch key control part 209 notifies the display control part 205 of the information of “Read Setting Information [03]” (S249).

The display control part 205 updates the display state of the display state management part 204 to “Copy” corresponding to the “Copy” function upon the receipt of information of “Read Setting Information [03]” (S250), and displays a screen (screen 404 in FIG. 30) that indicates that the setting information [03] for Copy is read is displayed on the display part 202 (S251).

Herein, as the setting information [03] for Copy, “Read Size: Letter” “Multiple Pages Per Sheet: 4 Pages (Vertical Alignment)” “Sheet Feeding Tray: Tray 1” “Enlarge/Reduce: Auto Select” etc. are set. In this case, as illustrated in the screen 404 in FIG. 30, the content of the setting information [03] is displayed on the display part 202.

(Fifth Time One Touch Key Pressing)

Furthermore, when the one touch key 203-14 that is a different one from the one pressed for the previous time (fourth time) is pressed and a pressing signal is notified from the one touch key 203-14 to the display control part 205 (S252), the display control part 205 performs a request to obtain display state information to the display state management part 204 (S253), and the display state management part 204 gives the display state information to the display control part 205 (S254).

For example, when a screen 404 in FIG. 30 is displayed on the display part 202, because a current display state thereof is “Copy,” display state information of “Copy” is given to the display control part 205.

The display control part 205 gives the classification [1] of the one touch key 203-14 and the display state information “Copy” to the one touch key control part 209 (S255).

The one touch key control part 209 notifies the key assignment switch control part 221 of the classification [1] of the one touch key 203-14, information that a different key has been pressed, and the display state information “Copy” (S256).

The key assignment switch control part 221 specifies a corresponding action (see “Read Setting Information (Scan To E-Mail)” in FIG. 19) based on the display state information “Copy” and the classification of a currently pressed one touch key (one touch key 203-14 herein), referring to the key assignment table in FIG. 19.

Then, because the currently pressed one touch key is different from the previously pressed key, the key assignment switch control part 221 selects the above-described specified action “Read Setting Information (Scan To E-Mail)”.

The key assignment switch control part 221 notifies the switch to the selected action “Read Setting Information” (S257), and the one touch key control part 209 deletes the previous setting information of the Copy function memorized in RAM 217, and updates to the setting information [01] of the Scan To Email function (S258).

Also, the one touch key control part 209 notifies the display control part 205 of the information of “Read Setting Information [01]” (S259).

The display control part 205 updates the display state of the display state management part 204 to “Scan To E-Mail” upon the receipt of information of “Read Setting Information [01]” (S260), and displays a screen (screen 405 in FIG. 30) that indicates that the setting information [01] of the Scan To E-Mail function has been read is displayed on the display part 202 (S261).

Herein, the setting information [01] of the Scan To E-Mail designates the address book [03] as a destination, and a reading setting is set. On the screen 405 in FIG. 30, a flag (black dot on the screen 405 in FIG. 30) is given as the reading setting is different from default.

(Sixth Time One Touch Key Pressing)

Furthermore, when the one touch key 203-15 that is a different one from the one pressed for the previous time (fifth time) is pressed and a pressing signal is notified from the one touch key 203-15 to the display control part 205 (S262), the display control part 205 performs a request to obtain display state information to the display state management part 204 (S263), and the display state management part 204 gives the display state information to the display control part 205 (S264).

For example, when a screen 405 in FIG. 30 is displayed on the display part 202, because a current display state thereof is “Scan To E-Mail,” display state information of “Scan To E-Mail” is given to the display control part 205.

The display control part 205 gives the classification [2] of the one touch key 203-15 and the display state information “Scan To E-Mail” to the one touch key control part 209 (S265).

The one touch key control part 209 notifies the key assignment switch control part 221 of the classification [2] of the one touch key 203-15, information that the different key has been pressed, and the display state information “Scan To E-Mail” (S256).

The key assignment switch control part 221 specifies a corresponding action (see “Designate Address Book [02]” in FIG. 19) based on the display state information “Scan To E-Mail” and the classification of a currently pressed one touch key (one touch key 203-15 herein), referring to the key assignment table in FIG. 19.

Then, because the currently pressed one touch key is different from the previously pressed key, the key assignment switch control part 221 selects the above-described specified action “Designate Address Book”.

The key assignment switch control part 221 notifies the switch to the selected action “Designate Address Book” (S267), and the one touch key control part 209 updates the destination of the Scan To E-Mail function memorized in the RAM 217 to the information of “Address Book [02]” (S268).

At this time, because the display state is “Scan To E-Mail” that is the same as the one for the previous (fifth) time, the one touch key control part 209 keeps the destination information designated in the previous (fifth) time in the RAM 217, and adds a destination designated in this time to the RAM 217. As a result, it is possible to perform e-mail communication to two destinations that are designated in the fifth and sixth time.

Also, the one touch key control part 209 notifies the display control part 205 of the information of “Designate Address Book [02]” (S269).

The display control part 205 updates the display state of the display state management part 204 to “Scan To E-Mail” upon the receipt of information of “Designate Address Book [02]” (S270), and displays a screen (screen 406 in FIG. 30) that indicates that information of the address book [02] has been added as a destination of the Scan To E-Mail function is displayed on the display part 202 (S271).

(B-2-4) Action Selection Process in Key Assignment Switch Control Part 221 at the Time of Nth (N≧2) or Subsequent Time Pressing of One Touch Key

Next, an action selection process in the key assignment switch control part 221 at the time of a second or subsequent time pressing of the one touch key is explained in detail referring to the drawings.

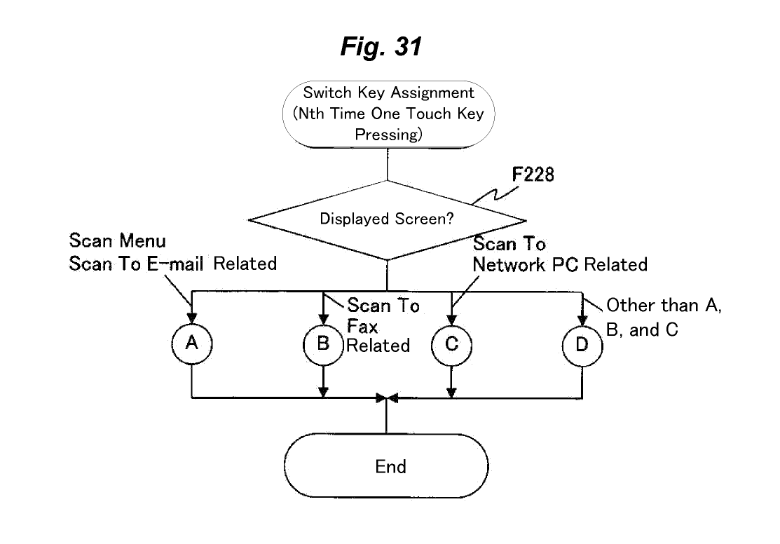

FIGS. 31-35 are flow diagrams that illustrate the action selection process in the key assignment switch control part 221 at the time of a second or subsequent time pressing of the one touch key

At F213 in FIG. 27, the key assignment switch control part 221 obtains combined information of one touch key classification information, judgment information that judges whether a currently pressed one touch key is the same as or different from a previously pressed key, and the display state information obtained at F202 as a one touch key pressing notification from the one touch key control part 209.

F228: The key assignment switch control part 221 judges a current display state of the display part 202 based on the obtained display state information.

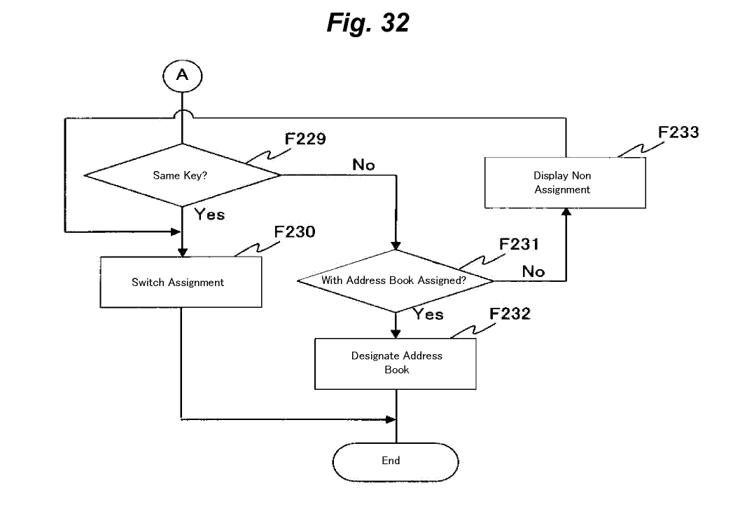

For example, the key assignment switch control part 221 shifts the process to F229 in FIG. 32 when the display state information is “Scan Menu” or “Scan To E-mail”.

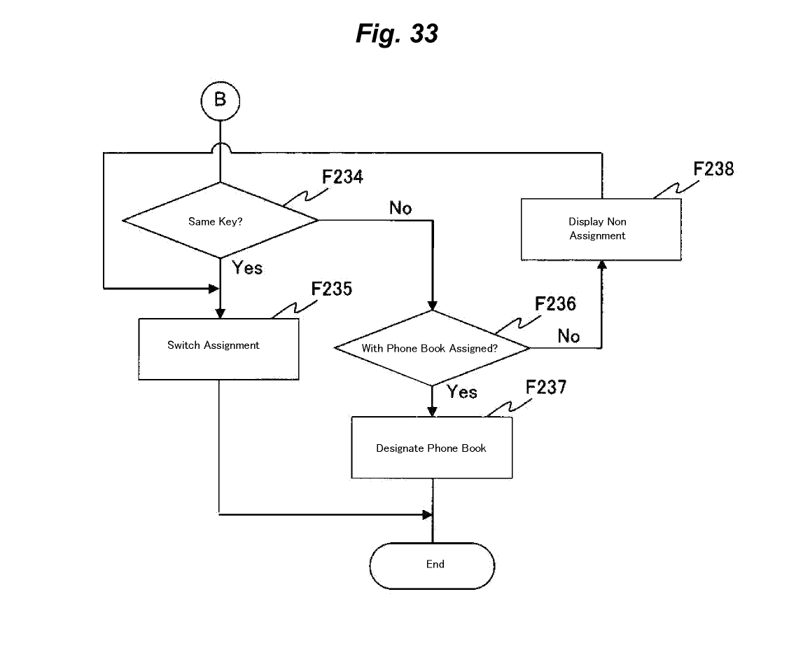

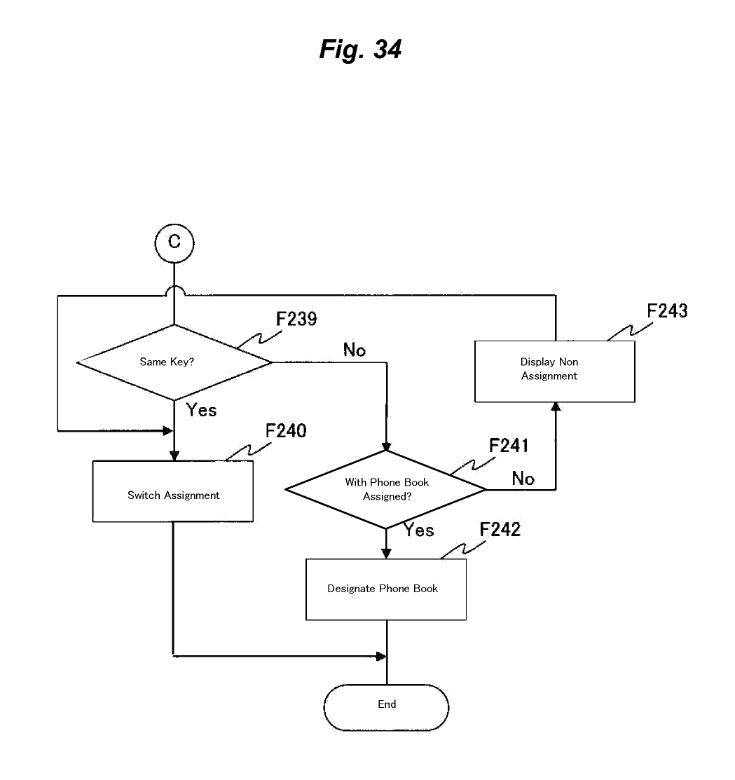

Also for example, when the display state information is “Scan To Fax,” the key assignment switch control part 221 shifts the process to F234 in FIG. 33, and when the display state information is “Scan To Network PC,” the key assignment switch control part 221 shifts the process to F239 in FIG. 34.

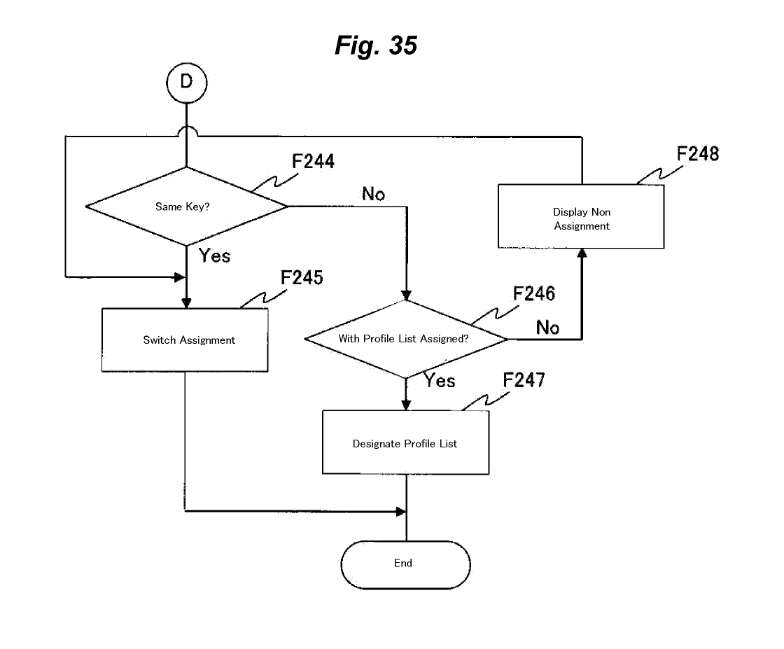

Also for example, when the display state information is one other than “Scan Menu,” “Scan To E-Mail,” “Scan To Fax,” and “Scan To Network PC,” the key assignment switch control part 221 shifts the process to F244 in FIG. 35.

F229: The key assignment switch control part 221 judges if a currently pressed one touch key is the same as a previously pressed one touch key or not. When the currently pressed one touch key is the same as the previously pressed key, the key assignment switch control part 221 shifts the process to F230, and when the currently pressed one touch key is different from the previously pressed key, the key assignment switch control part 221 shifts the process to F231.

F230: When the currently pressed one touch key is the same as the previously pressed one touch key, the key assignment switch control part 221 switches to an action assigned to the next one touch key from the action assigned to the one touch key corresponding to a current display state following the action switch order in FIG. 9, referring to the key assignment table in FIG. 19, and then ends the process.

F231: When the currently pressed one touch key is different from the previously pressed key, the key assignment switch control part 221 confirms if the address book corresponding to the display state of “Scan Menu” or “Scan To E-Mail” is assigned to the one touch key based on the classification information of the currently pressed one touch key, referring to the key assignment table in FIG. 19.

When the address book is assigned, the key assignment switch control part 221 shifts the process to F232, and when the address book is not assigned, the key assignment switch control part 221 shifts the process to F233.

F232: When the address book is assigned, the key assignment switch control part 221 selects “Designate Address Book” that is assigned, and notifies the one touch key control part 209 of the selected “Designate Address Book”.

F233: When the address book is not assigned, the key assignment switch control part 221 notifies the one touch key control part 221 of information that an assignment action is not registered in the one touch key, and displays a screen that indicates that no corresponding assignment information exists on the display part 202.

Also, the key assignment switch control part 221 shifts the process to F230. By shifting the process back to F230, it is possible to consider as the same one touch key. As a result, it is possible to switch to different assignment information that is assigned to a currently pressed one touch key. As the method to switch to the different assignment information, the same process as the process at F218 in FIG. 23 may be performed. As a result, even when the assignment information corresponding to the display state “Scan Menu” or “Scan To E-Mail” is not set, another action assigned to the currently pressed one touch key can be displayed to a user, so that user convenience can be improved.

F234: The key assignment switch control part 221 judges if a currently pressed one touch key is the same as a previously pressed one touch key or not. When the currently pressed one touch key is the same as the previously pressed key, the key assignment switch control part 221 shifts the process to F235, and when the currently pressed one touch key is different from the previously pressed key, the key assignment switch control part 221 shifts the process to F236.

F235: When the currently pressed one touch key is the same as the previously pressed one touch key, the key assignment switch control part 221 switches to an action assigned to the next one touch key from the action assigned to the one touch key corresponding to a current display state following the action switch order in FIG. 9, referring to the key assignment table in FIG. 19, and then ends the process.

F236: When the currently pressed one touch key is different from the previously pressed key, the key assignment switch control part 221 confirms if the phone book corresponding to the display state of “Scan To FAX” is assigned to the one touch key based on the classification information of the currently pressed one touch key, referring to the key assignment table in FIG. 19.

When the phone book is assigned, the key assignment switch control part 221 shifts the process to F237, and when the phone book is not assigned, the key assignment switch control part 221 shifts the process to F238.

F237: When the phone book is assigned, the key assignment switch control part 221 selects “Designate Phone Book” that is assigned, and notifies the one touch key control part 209 of the selected “Designate Phone Book”.

F233: When the phone book is not assigned, the key assignment switch control part 221 notifies the one touch key control part 221 of information that an assignment action is not registered in the one touch key, and displays a screen that indicates that no corresponding assignment information exists on the display part 202. To the process at F238, the same process as the process at F233 is applicable.

F239: The key assignment switch control part 221 judges if a currently pressed one touch key is the same as a previously pressed one touch key or not. When the currently pressed one touch key is the same as the previously pressed key, the key assignment switch control part 221 shifts the process to F240, and when the currently pressed one touch key is different from the previously pressed key, the key assignment switch control part 221 shifts the process to F241.

F240: When the currently pressed one touch key is the same as the previously pressed one touch key, the key assignment switch control part 221 switches to an action assigned to the next one touch key from the action assigned to the one touch key corresponding to a current display state following the action switch order in FIG. 9, referring to the key assignment table in FIG. 19, and then ends the process.

F241: When the currently pressed one touch key is different from the previously pressed key, the key assignment switch control part 221 confirms if the profile list corresponding to the display state of “Scan To NetworkPC” is assigned to the one touch key based on the classification information of the currently pressed one touch key, referring to the key assignment table in FIG. 19.

When the profile list is assigned, the key assignment switch control part 221 shifts the process to F242, and when the profile list is not assigned, the key assignment switch control part 221 shifts the process to F243.

F242: When the profile list is assigned, the key assignment switch control part 221 selects the assigned “Designate Profile List,” and notifies the one touch key control part 209 of the selected “Designate Profile List”.

F243: When the profile list is not assigned, the key assignment switch control part 221 notifies the one touch key control part 221 of information that an assignment action is not registered in the one touch key, and displays a screen that indicates that no corresponding assignment information exists on the display part 202. To the process at F243, the process the same as the process at F233 is applicable.

F244: For example when the display state is “Copy” or “Print,” the key assignment switch control part 221 judges if a currently pressed one touch key is the same as a previously pressed one touch key or not. When the currently pressed one touch key is the same as the previously pressed key, the key assignment switch control part 221 shifts the process to F245, and when the currently pressed one touch key is different from the previously pressed key, the key assignment switch control part 221 shifts the process to F246.

F245: When the currently pressed one touch key is the same as the previously pressed one touch key, the key assignment switch control part 221 switches to an action assigned to the next one touch key from the action assigned to the one touch key corresponding to a current display state following the action switch order in FIG. 9, referring to the key assignment table in FIG. 19, and then ends the process.

F246: When the currently pressed one touch key is different from the previously pressed key, the key assignment switch control part 221 confirms if the setting information corresponding to the display state of “Copy” or “Print” is assigned to the one touch key based on the classification information of the currently pressed one touch key, referring to the key assignment table in FIG. 19.

When the address book is assigned, the key assignment switch control part 221 shifts the process to F247, and when the address book is not assigned, the key assignment switch control part 221 shifts the process to F248.

F247: When the address book is assigned, the key assignment switch control part 221 selects “Read Setting Information” that is assigned, and notifies the one touch key control part 209 of the selected “Read Setting Information”.

F248: When the setting information is not assigned, the key assignment switch control part 221 notifies the one touch key control part 221 of information that an assignment action is not registered in the one touch key, and displays a screen that indicates that no corresponding assignment information exists on the display part 202. To the process at F248, the process same as the process at F233 is applicable.

(B-3) Effect of Second Embodiment

As described above, according to the second embodiment, even when assignment actions are assigned to plural number of pieces of one touch keys, in addition to the effects according to the first embodiment, plural actions assigned to the one touch keys can be switched in correspondence with a display state at a moment.

### (C) Other Embodiments

(C-1) In the above-described first embodiment and second embodiment, cases where the present invention is applied to an image processing apparatus. However, the present invention is applicable to user interfaces of mobile terminals that control a device by screen operation (for example, mobile telephone devices including so-called smart phones, tablet terminals, etc.) and printer drivers.

(C-2) In the above-described first embodiment and second embodiment, examples of cases that plural functions by display states are assigned to respective operation keys and functions corresponding to a display state when the operation keys are pressed is selected are described. However, states for the image forming apparatus are not limited to the display states, and it may possible to select functions assigned to the operation keys depending on error status.

For example, when the FAX function is in an error state in the image forming apparatus, the one touch key control part may select and switch to a different action out of assignment actions assigned to the operation key without performing an action of the FAX function. Also for example, when the network communication function is in an error state, the one touch key control part may select and switch to a different action without performing an email function assigned to the operation key.

### Supplemental Definitions

(1) Switching the screen of the display part, which is recited in claim 3, means a switching process of screen between the first and second display screens. For example, in FIG. 16, it is illustrated that SCAN TO EMAIL display (301) to function to scan is converted to FAX display (302) to function to facsimile.
(2) A setting screen related to data transmission, which is recited in claim 5, means any type of display screen in which the user can set up a data transmission process. The term includes “SCAN MENU, SCAN TO EMAIL,” “SCAN TO FAX,” and “SCAN TO NETWORK PC” etc.

What is claimed is:

1. An image processing apparatus, comprising:
a display part that displays a screen;
a display control part that displays one of a first display screen and a second display screen on the display part;
a first operation key that is pressed by a user, and
a control part that
executes a first process when the first operation key is pressed by the user while the first display screen is displayed on the display part, and
executes a second process when the first operation key is pressed by the user while the second display screen is displayed on the display part.

2. The image processing apparatus according to claim 1, further comprising:
a memory part that memorizes setting information, wherein
the control part reads setting information memorized in the memory part and controls the display control part such that the first display screen reflects the setting information as the first process, and
the control part reads other setting information memorized in the memory part and controls the display control part such that the second display screen reflects the other setting information as the second process.

3. The image processing apparatus according to claim 1, wherein
the control part switches the screen of the display part to the second display screen when the first operation key is repeatedly pressed by the user while the first display screen is displayed on the display part.

4. The image processing apparatus according to claim 3, wherein
the control part switches the screen of the display part to the first display screen when the first operation key is repeatedly pressed by the user while the second display screen is displayed on the display part.

5. The image processing apparatus according to claim 2, wherein
the first display screen is a setting screen related to copier,
the second display screen is a setting screen related to data transmission,
the control part reads the setting information related to the copier, which is memorized in the memory part, as the first process, and
the control part reads the setting information that indicates a transmission destination of the data transmission, which is memorized in the memory part, as the second process.

6. The image processing apparatus according to claim 2, wherein
the first display screen is a setting screen related to copier,
the second display screen is another setting screen related to data transmission,
the control part reads setting information related to the copier, which is memorized in the memory part, as the first process, and
the control part reads other setting information that indicates a transmission destination of the data transmission, which is memorized in the memory part, as the second process.

7. The image processing device according to claim 1, wherein
the first operation key is a physical key.

8. The image processing apparatus according to claim 4, further comprising:
a second operation key that is pressed by the user, which is another key from the first operation key, wherein
the control part
executes a third process when the second operation key is pressed by the user while the first display screen is displayed on the display part, and
executes a fourth process when the second operation key is pressed by the user while the second display screen is displayed on the display part.

9. The image processing apparatus according to claim 8, wherein
the control part:
switches the screen of the display part to the second display screen when the second operation key is repeatedly pressed by the user while the first display screen is displayed on the display part; and
switches the screen of the display part to the first display screen when the second operation key is repeatedly pressed by the user while the second display screen is displayed on the display part.

10. The image processing device according to claim 9, wherein
the first operation key and the second operation key are physical keys.

11. The image processing device according to claim 1, wherein
the first display screen is related to a first function initiated by the first operation key,
the second display screen is related to a second function initiated by the second operation key,
the first process is a process related to the first function, and
the second process is another process related to the second function.

12. The image processing device according to claim 8, wherein
the first display screen is related to a first function initiated by the first operation key,
the second display screen is related to a second function initiated by the second operation key,
the first process is a process related to the first function,
the second process is another process related to the second function,
the third process is another process related to the first function,
the fourth process is another process related to the second function.
